(19) United States
(12) Patent Application Publication
(10) Pub. No.: US 2025/0238186 A1
(43) Pub. Date: Jul. 24, 2025

(54) DEVICE AND METHOD FOR MIRRORING RELATED CONTENT

(71) Applicant: Samsung Electronics Co., Ltd., Suwon-si (KR)

(72) Inventors: Ilku CHANG, Suwon-si (KR); Hayeon YOO, Suwon-si (KR)

(21) Appl. No.: 19/082,982

(22) Filed: Mar. 18, 2025

Related U.S. Application Data
(63) Continuation of application No. PCT/KR2023/015613, filed on Oct. 11, 2023.

(30) Foreign Application Priority Data
Oct. 11, 2022 (KR) 10-2022-0129725
Nov. 10, 2022 (KR) 10-2022-0149533

(51) Int. Cl. G06F 3/14

(52) U.S. Cl. CPC G06F 3/1454

(57) ABSTRACT

A first device for mirroring content to a second device is provided. The first device includes a communication interface, a display, memory storing one or more computer programs, and one or more processors communicatively coupled to the communication interface, the display, and the memory, wherein the one or more processors include computer-executable instructions that, when executed by the one or more processors individually or collectively, cause the first device to display first content on a screen of the first device, receive, from the second device, information related to second content that is being displayed on a screen of the second device, compare the information related to the second content with information related to the first content and determine whether the first content is related to the second content, output a notification inquiring user whether to mirror the first content to the second device when it is determined that the first content is related to the second content, receive a user input with respect to the notification, and mirror the first content to the second content in response to receiving the user input.

### CROSS-REFERENCE TO RELATED APPLICATION(S)

This application is a continuation application, claiming priority under 35 U.S.C. § 365 (c), of an International application No. PCT/KR2023/015613, filed on Oct. 11, 2023, which is based on and claims the benefit of a Korean patent application number 10-2022-0129725, filed on Oct. 11, 2022, in the Korean Intellectual Property Office, and of a Korean patent application number 10-2022-0149533, filed on Nov. 10, 2022, in the Korean Intellectual Property Office, the disclosure of each of which is incorporated by reference herein in its entirety.

### BACKGROUND

### 1. Field

The disclosure relates to a device and method for mirroring related content.

### 2. Description of Related Art

As multimedia and network technologies have developed, users have been able to receive various services by utilizing a plurality of devices. The plurality of devices can include various devices such as large-screen devices and small-screen devices. While the user receives content through the large-screen device, the user can receive other content through the small-screen device. The large-screen device can provide a lot of content through a wide screen, but has a problem that it is difficult to efficiently select related content of the small-screen device and provide it to the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and method for mirroring related content.

Additional aspects will be set forth in part in the description which follows and, in part, will be apparent from the description, or may be learned by practice of the presented embodiments.

In accordance with an aspect of the disclosure, a first device for mirroring content to a second device, is provided. The first device includes a communication interface, a display, memory storing one or more computer programs, and one or more processors communicatively coupled to the communication interface, the display and the memory, wherein the one or more processors include computer-executable instructions that, when executed by the one or more processors individually or collectively, cause the first device to display first content on a screen of the first device, receive, from the second device, information related to second content that is being displayed on a screen of the second device, compare the information related to the second content with information related to the first content and determine whether the first content is related to the second content, output a notification inquiring a user whether to mirror the first content to the second device when it is determined that the first content is related to the second content, receive a user input with respect to the notification, and mirror the first content to the second device in response to receiving the user input.

In accordance with another aspect of the disclosure, a method performed by a first device for mirroring content to a second device is provided. The method includes displaying, by the first device, first content on a screen of the first device, receiving, by the first device from the second device, information related to second content that is being displayed on a screen of the second device, comparing, by the first device, the information related to the second content with information related to the first content and determining, by the first device, whether the first content is related to the second content, outputting, by the first device, a notification inquiring a user whether to mirror the first content to the second device based on determining that the first content is related to the second content, receiving, by the first device, a user input with respect to the notification, and mirroring, by the first device, the first content to the second device in response to receiving the user input.

In accordance with another aspect of the disclosure, one or more non-transitory computer-readable storage media storing one or more computer programs including computer-executable instructions that, when executed by the one or more processors of a first device individually or collectively, cause the first device to perform operations are provided. The operations include displaying, by the first device, first content on a screen of the first device, receiving, by the first device from a second device, information related to second content that is being displayed on a screen of the second device, comparing, by the first device, the information related to the second content with information related to the first content and determining, by the first device, whether the first content is related to the second content, outputting, by the first device, a notification inquiring a user whether to mirror the first content to the second device based on determining that the first content is related to the second content, receiving, by the first device, a user input with respect to the notification, and mirroring, by the first device, the first content to the second device in response to receiving the user input.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a system for allowing a first device to mirror content to a second device according to an embodiment of the disclosure;

FIG. 2 is a flowchart of a method in which a first device mirrors content to a second device according to an embodiment of the disclosure;

FIG. 3 is a flowchart of a method in which a first device determines related content by using second metadata received from a server and mirrors first content to a second device according to an embodiment of the disclosure;

FIG. 4 is a flowchart of a method in which a server determines related content and a first device mirrors first content to a second device according to an embodiment of the disclosure;

FIG. 5 is a flowchart of a method in which a first device determines related content by using second metadata received from a second device and mirrors first content to the second device according to an embodiment of the disclosure;

FIG. 6 is a flowchart of a method in which a first device controls second content that is being played by a second device, determines related content by using second metadata of the second content, and mirrors first content to the second device according to an embodiment of the disclosure;

FIG. 7 is a diagram showing an example in which a first device mirrors a first multimedia content to a second device while the first multimedia content is displayed on a screen of the first device and a second multimedia content is displayed on a screen of the second device according to an embodiment of the disclosure;

FIG. 8 is a diagram showing an example in which a first device mirrors an application execution screen to a second device while the application execution screen is displayed on a screen of the first device and a second multimedia content is displayed on a screen of the second device according to an embodiment of the disclosure;

FIG. 9 is a diagram showing a method in which a first device determines related content, based on an input query input by a user through first content, and mirrors the first content to a second device according to an embodiment of the disclosure;

FIG. 10 is a diagram showing an example in which a first device mirrors an execution screen of a search application to a second device, based on an input query input through the execution screen of the search application on a screen of the first device according to an embodiment of the disclosure;

FIG. 11 is a diagram showing an example in which a first device mirrors a video application execution screen to a second device, based on an input query input through the video application execution screen on a screen of the first device according to an embodiment of the disclosure;

FIG. 12 is a diagram showing an example of presenting a notification for recommending mirroring to a screen of a first device, based on the number of users who view a first multimedia content on the screen of the first device and a second multimedia content on a screen of a second device according to an embodiment of the disclosure;

FIG. 13 is a flowchart of a method in which a first device mirrors at least one of a plurality of contents to a second device while displaying the plurality of contents together according to an embodiment of the disclosure;

FIG. 14 is a diagram showing an example in which a first device mirrors at least one of a plurality of application execution screens to a second device while displaying the application execution screens together through a multi view function according to an embodiment of the disclosure;

FIG. 15 is a block diagram of an electronic device in a network environment according to an embodiment of the disclosure; and

FIG. 16 is a block diagram of a server according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, terms such as first, second, etc. may be used to describe various components, but the components should not be limited by these terms. These terms are used for the purpose of distinguishing one component from another component.

Throughout the specification, when a certain portion is said to be “connected” to another portion, this includes not only a case where it is “directly connected” but also a case where it is “electrically connected” with another element located therebetween. In addition, when a certain portion is said to “include” a certain component, this does not mean excluding another component unless specifically stated otherwise, but rather means that it may further include another component.

Phrases such as “in an embodiment” appearing in various places in the disclosure do not necessarily all refer to the same embodiment.

An embodiment of the disclosure may be represented by functional block constructions and various processing operations. Some or all of these functional blocks may be implemented by various numbers of hardware and/or software constructions performing specific functions. For example, the functional blocks of the disclosure may be implemented by one or more microprocessors, or be implemented by circuit constructions for a predefined function. In addition, for example, the functional blocks of the disclosure may be implemented by various programming or scripting languages. The functional blocks may be implemented by algorithms that are executed in one or more processors. In addition, the disclosure may employ the conventional art for the sake of electronic environment settings, signal processing, and/or data processing, etc. Terms such as “mechanism,” “element,” “means,” and “construction” may be used broadly, and are not limited to mechanical and physical constructions.

In addition, connection lines or connection members between components illustrated in the drawings exemplarily merely represent functional connections and/or physical or circuit connections. In an actual device, connections between the components may be represented by replaceable or added various functional connections, physical connections, or circuit connections.

In this document, “content” may mean digital information presented through wired or wireless communication networks. Content of an embodiment of the disclosure may include, but is not limited to, video content (e.g., television (TV) program video, video on demand (VOD), personal video (user-created contents (UCC)), music video, YouTube video, etc.), still image content (e.g., photograph, picture, etc.), text content (e.g., e-book (poem, novel), letter, work file), music content (e.g., music, instrumental music, radio broadcast, etc.), web page, application execution information, etc.

The disclosure will be described below in detail with reference to the accompanying drawings.

A first device for mirroring content to a second device of an embodiment of the disclosure may include a communication interface, a display, memory configured to store instructions, and a processor operatively connected to the communication interface, the display and the memory and configured to execute the instructions. The processor may execute the instructions to display first content on a screen of the first device, determine whether the first content is related to second content that is being displayed on a screen of the second device, output a notification for inquiring of a user whether to mirror the first content to the second device as the first content is related to the second content, receive a user input with respect to the notification, and mirror the first content to the second device in response to receiving the user input.

In addition, whether the first content is related to the second content may be determined based on first metadata of the first content and second metadata of the second content.

In addition, the first device and the second device may be devices registered with a server presenting an Internet of Things (IoT) service. The processor may execute the instructions to request the second metadata of the second content from the server, receive the second metadata of the second content from the server, and compare the first metadata of the first content with the second metadata of the second content.

In addition, the processor may execute the instructions to execute a remote control application for controlling the second content displayed on the screen of the second device, control the second content displayed on the screen of the second device through the remote control application, and identify the second content, based on the controlling of the second content. The processor may execute the instructions to receive the second metadata of the second content from the second device, and compare the first metadata of the first content with the second metadata of the second content.

In addition, the processor may execute the instructions to receive the second metadata from the second device through the remote control application.

In addition, the first content may be multimedia content, and the first metadata of the first content may include at least one of a name, genre, category, or character of the multimedia content.

In addition, the first content may be an application presenting a specific service, and the first metadata of the first content may include at least one of a name of the application, a category, or a keyword included in an execution screen of the application.

In addition, the first metadata may include an input query input by a user to the first device in relation to the first content.

In addition, the processor may execute the instructions to identify a plurality of users who view the first content displayed on the screen of the first device and the second content displayed on the screen of the second device, the plurality of users including the user, and output the notification, as the first content is related to the second content and the plurality of users are identified.

In addition, the processor may execute the instructions to display the first content and third content together on the screen of the first device, and display a graphical user interface (GUI) for mirroring at least one of the first content or the third content to the second device, in at least one of an area where the first content is displayed or an area where the third content is displayed.

In addition, a method for mirroring, by a first device, content to a second device of an embodiment of the disclosure may include displaying first content on a screen of the first device, determining whether the first content is related to second content that is being displayed on a screen of the second device, outputting a notification for inquiring of a user whether to mirror the first content to the second device as the first content is related to the second content, receiving a user input with respect to the notification, and mirroring the first content to the second device in response to receiving the user input.

In addition, whether the first content is related to the second content may be determined based on first metadata of the first content and second metadata of the second content.

In addition, the first device and the second device may be devices registered with a server presenting an IoT service, and the determining of whether the first content is related to the second content may include requesting the second metadata of the second content from the server, receiving the second metadata of the second content from the server, and comparing the first metadata of the first content with the second metadata of the second content.

In addition, the method may further include executing a remote control application for controlling the second content displayed on the screen of the second device, controlling the second content displayed on the screen of the second device through the remote control application, and identifying the second content, based on the controlling of the second content. In addition, the determining of whether the first content is related to the second content may include receiving the second metadata of the second content from the second device, and comparing the first metadata of the first content with the second metadata of the second content.

In addition, the receiving of the second metadata of the second content may receive the second metadata from the second device through the remote control application.

In addition, the first content may be multimedia content, and the first metadata of the first content may include at least one of a name, genre, category, or character of the multimedia content.

In addition, the first content may be an application presenting a specific service, and the first metadata of the first content may include at least one of a name of the application, a category, or a keyword included in an execution screen of the application.

In addition, the first metadata may include an input query input by a user to the first device in relation to the first content.

In addition, the method may further include identifying a plurality of users who view the first content displayed on the screen of the first device and the second content displayed on the screen of the second device, the plurality of users including the user. The outputting of the notification for inquiring of the user whether to mirror the first content to the second device may output the notification, as the first content is related to the second content and the plurality of users are identified.

In addition, an embodiment of the disclosure may present a computer-readable recording medium recording a program for executing a method for mirroring, by a first device, content to a second device, the method including displaying first content on a screen of the first device, determining whether the first content is related to second content that is being displayed on a screen of the second device, outputting a notification for inquiring of a user whether to mirror the first content to the second device as the first content is related to the second content, receiving a user input with respect to the notification, and mirroring the first content to the second device in response to receiving the user input.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

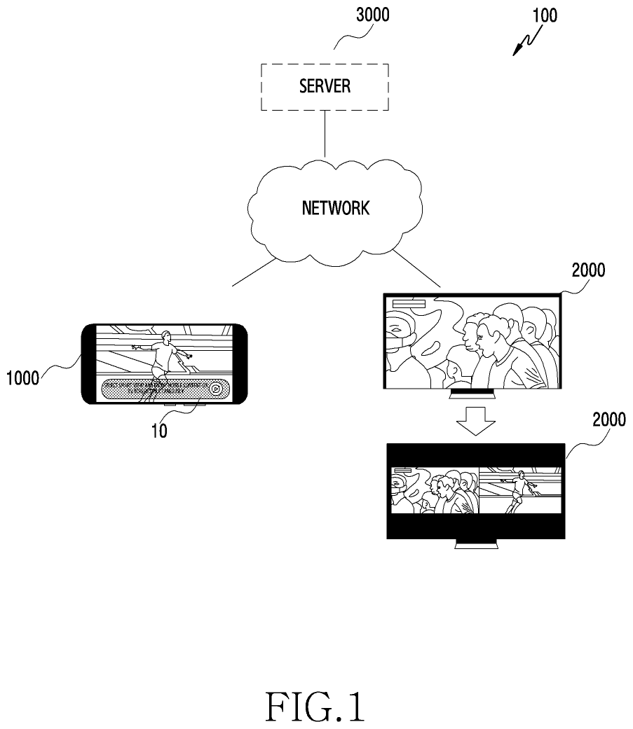

FIG. 1 is a schematic diagram of a system for allowing a first device to mirror content to a second device according to an embodiment of the disclosure.

Referring to FIG. 1, a system 100 presenting a mirroring service of an embodiment may include a first device 1000, a second device 2000, and a server 3000. The first device 1000 is a device having a small-screen display and may be, for example, a smartphone. The second device 2000 is a device having a large-screen display and may be, for example, a TV. The server 3000 may register and manage a plurality of devices of a user and present an Internet of Things (IoT) service to the user.

While the user is viewing second content that is being displayed on a screen of the second device 2000, first content may be displayed on a screen of the first device 1000. The first device 1000 may identify whether the first content displayed on the screen of the first device 1000 is related to the second content displayed on the screen of the second device 2000. When it is identified that the first content is related to the second content, the first device 1000 may display, on the screen of the first device 1000, a notification 10 for inquiring of the user whether to mirror the first content to the second device 2000, and mirror the first content to the second device 2000 in response to a user input with respect to the notification 10.

The first device 1000 is a device capable of presenting a mirroring function, and may be, for example, a smartphone, a tablet PC, a mobile phone, a personal digital assistant (PDA), a laptop, a media player, a global positioning system (GPS) device, an e-book reader, a digital broadcasting terminal, a navigation device, a digital camera, a wearable device, a home appliance, or other mobile computing devices, but is not limited thereto.

The second device 2000 is a device capable of receiving the first content presented from the first device 1000 and displaying the first content and the second content together, and may be a device having a screen larger than the screen of the first device 1000. The second device 2000 may be, but is not limited to, a smart TV, a portable communication device (e.g., smartphone), a computer device, a portable multimedia device, a portable medical device, a camera, a wearable device, a home appliance device, or other mobile or non-mobile computing devices.

A network may be implemented as a wired network such as a local area network (LAN), a wide area network (WAN) or a value added network (VAN), or all types of wireless networks such as a mobile radio communication network or a satellite communication network. In addition, the network may include a combination of at least two or more of the local area network, the wide area network, the value added network, the mobile radio communication network, or the satellite communication network, and is a comprehensive data communication network allowing respective network components illustrated in FIG. 1 to communicate smoothly with each other, and includes a wired Internet, a wireless Internet, and a mobile radio communication network. Wireless communication may include, but is not limited to, wireless LAN (Wi-Fi), Bluetooth™, Bluetooth™ low energy (BLE), Zigbee, Wi-Fi Direct (WFD), ultra wideband (UWB), infrared communication (infrared data association (IrDA)), near field communication (NFC), etc.

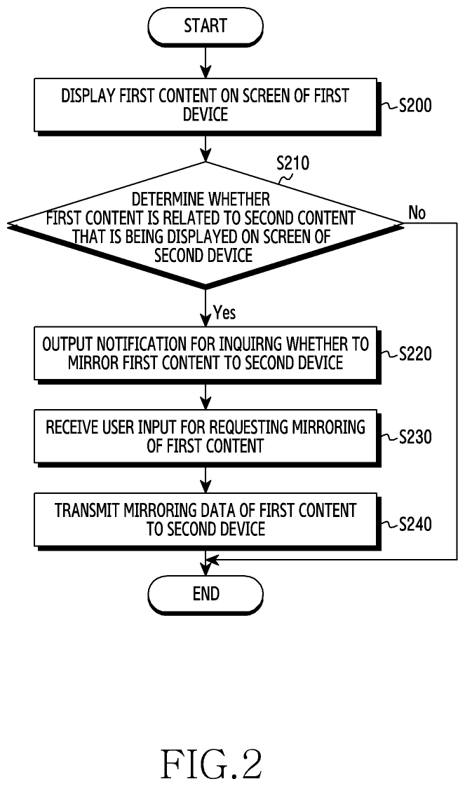

FIG. 2 is a flowchart of a method in which a first device mirrors content to a second device according to an embodiment of the disclosure.

In operation S200, a first device 1000 may display first content on a screen of the first device 1000. The first device 1000 may display the first content on the screen of the first device 1000 while second content is being displayed on a screen of a second device 2000.

The first content and/or the second content may be digital information presented through a wired or wireless communication network. The first content and/or the second content of an embodiment may include, but are not limited to, video content (e.g., TV program video, video on demand (VOD), personal video (user-created contents (UCC)), music video, YouTube video, etc.), still image content (e.g., photo, picture, etc.), text content (e.g., e-book (poem, novel), letter, work file), web page, application execution information, etc.

For example, the first content may include, but is not limited to, multimedia content and/or an application execution screen. For example, when the first device 1000 is a smartphone, the first content may be a video, or an execution screen of a specific application, displayed on the screen of the first device 1000. The application may be software that is executed on a computer operating system (OS) or a mobile OS and is used by a user. For example, the application may include, but is not limited to, a word processor, a spreadsheet, a contacts application, a calendar application, a memo application, an alarm application, a social network system (SNS) application, a chatting application, a map application, a music player, or a video player.

For example, the second content may include, but is not limited to, multimedia content and/or an application execution screen. For example, when the second device 2000 is a TV, the second content may be content of a TV program that is being displayed on the screen of the second device 2000.

In operation S210, the first device 1000 may identify whether the first content is related to the second content that is being displayed on the screen of the second device 2000. When the display of the first content starts on the screen of the first device 1000 while the second content is being displayed on the screen of the second device 2000, the first device 1000 may identify whether the first content is related to the second content. The first device 1000 may compare first metadata of the first content with second metadata of the second content and determine or identify whether the first content is related to the second content.

For example, when the content is news content, the metadata may include a representative keyword presented as a news text, a representative image (e.g., character), and/or video information. For example, when the content is a video, the metadata may include a title, a character, a genre, playing time, a file size and/or a representative image (e.g., movie poster) of the video content. For example, when the content is a user address book, the metadata may include a name, a phone number, a group, an email, an address and/or a memo. For example, when the content is a photograph, the metadata may include theme and event (e.g., family trip and summer vacation) information extracted from an image, time information, location information using GPS information, and/or character information in the photograph image. For example, when the content is a music video, the metadata may include title, record (album) name, singer name, genre, songwriter, and/or release date information. When the content is a television program, the metadata is general information about a program presented by broadcasting and may include a program name, time, a character, and/or a genre. For example, when the content is a video of a sports game, the metadata may include a game type, a league name, and/or a player name. For example, when the content is application execution information, the metadata may include a name of an application, a category, a keyword within an execution screen, and/or an input query input to the application.

According to an embodiment, when the first device 1000 is communicatively connected to the second device 2000, the first device 1000 may receive the second metadata of the second content from the second device 2000, and compare the first metadata with the received second metadata.

According to an embodiment, when the first device 1000 is connected to the server 3000, the first device 1000 may receive the second metadata of the second content from the server 3000, and compare the first metadata with the received second metadata.

According to an embodiment, when the first device 1000 and the second device are connected to the server 3000, the server 3000 may receive the first metadata of the first content from the first device 1000, receive the second metadata of the second content from the second device 2000, and compare the first metadata with the second metadata. The server 3000 may determine whether the first content is related to the second content, based on the comparison result of the first metadata and the second metadata, and present the determination result to the first device 1000.

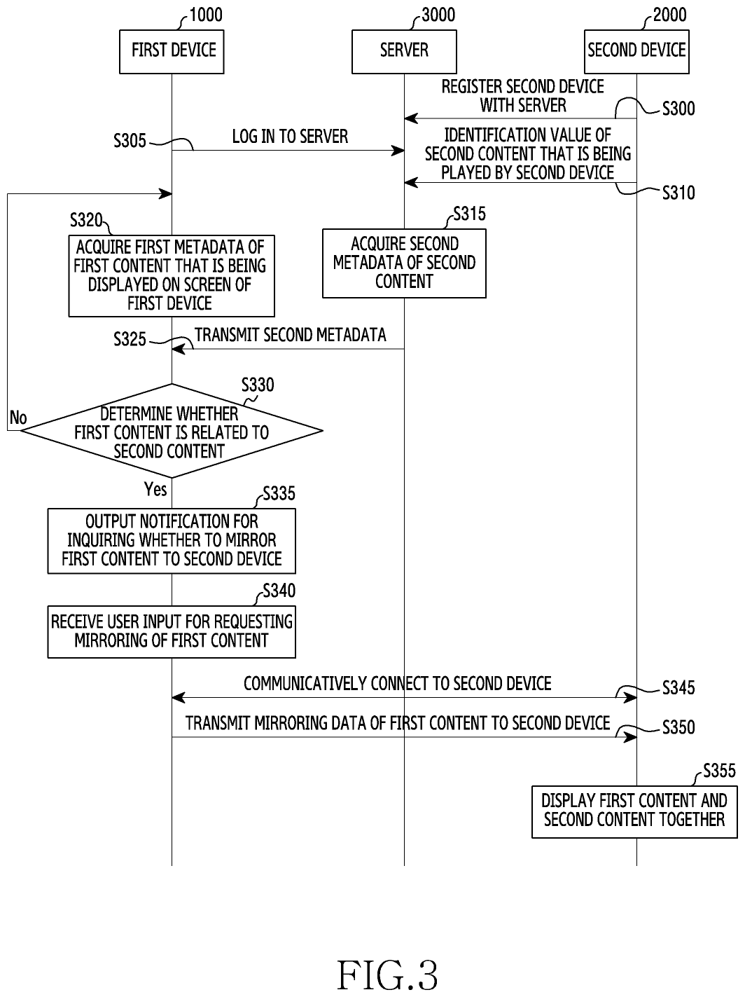

A method in which the first device 1000 identifies whether the first content is related to the second content will be described in more detail with reference to FIGS. 3 to 5.

When it is determined that the first content is related to the second content as the determination result of operation 210, in operation S220, the first device 1000 may output a notification for inquiring of the user whether to mirror the first content to the second device 2000. The first device 1000 may display, on the screen of the first device 1000, a graphical user interface (GUI) including a text and/or icon for inquiring whether to mirror the first content to the second device 2000. For example, the first device 1000 may overlap and display a GUI for inquiring whether to mirror the first content, on the first content that is being displayed on the screen of the first device 1000. For example, the first device 1000 may display, on the first content, a GUI including a text ‘Select Smart View and enjoy mobile content on TV screen simultaneously.’ and an icon for initiating mirroring.

In operation S230, the first device 1000 may receive a user input for requesting mirroring of the first content. For example, the first device 1000 may receive a user input for selecting a specific icon within the GUI for inquiring whether to mirror the first content.

In operation S240, the first device 1000 may mirror the first content to the second device 2000. The first device 1000 may complete a communication connection for mirroring with the second device 2000 and transmit mirroring data of the first content to the second device 2000. The first device 1000 may be connected to the second device 2000 through, for example, wireless LAN (Wi-Fi), Bluetooth™, BLE, Zigbee, Wi-Fi Direct (WFD), ultra wideband (UWB), infrared communication (infrared data association (IrDA)) or near field communication (NFC). When communication for mirroring is already connected between the first device 1000 and the second device 2000, a communication connection operation for mirroring between the first device 1000 and the second device 2000 may be omitted.

FIG. 3 is a flowchart of a method in which a first device determines related content by using second metadata received from a server and mirrors first content to a second device according to an embodiment of the disclosure.

In operation S300, a second device 2000 may register the second device 2000 with a server 3000. The server 3000 may present IoT services for user's devices, and a user may register the second device 2000 with the server 3000. The second device 2000 may be registered as a device for a user account of a user who has subscribed to the service of the server 3000. In operation S300, the second device 2000 is described as registering the second device 2000 with the server 3000, but is not limited thereto. The user may register the second device 2000 with the server 3000 by using another device.

In operation S305, a first device 1000 may log in to the server 3000. The first device 1000 may be registered with the IoT service of the server 3000, and the first device 1000 may log in to the IoT service of the server 3000 by using user account information.

In operation S310, the second device 2000 may transmit an identification value of second content that is being played by the second device 2000, to the server 3000. As the second content is displayed by the second device 2000, the second device 2000 may present the identification value of the second content to the server 3000 for the sake of presenting of the IoT service. For example, when a broadcast program is displayed on a screen of the second device 2000, the second device 2000 may transmit a name or channel name of the displayed broadcast program to the server 3000.

In operation S315, the server 3000 may acquire second metadata of the second content. The server 3000 may acquire the second metadata of the second content, based on the identification value of the second content. Based on the identification value of the second content, the server 3000 may request the second metadata of the second content from another server (not shown) that is presenting the second content to the second device 2000, and receive the second metadata from another server (not shown). Alternatively, the server 3000 may receive the second metadata together with the identification value of the second content from the second device 2000. When the second device 2000 is registered with the IoT service of the server 3000, the server 3000 may monitor, in real time, information about the second content that is being displayed by the second device 2000.

In operation S320, the first device 1000 may acquire first metadata of first content that is being displayed on a screen of the first device 1000, and in operation S325, the server 3000 may transmit the second metadata of the second content to the first device 1000.

In operation S330, the first device 1000 may determine whether the first content is related to the second content. The first device 1000 may compare the first metadata with the second metadata and determine whether the first content is related to the second content. In order to determine whether the contents are related to each other, the metadata related to each other may be defined in advance.

According to an embodiment, when the first content and the second content are videos, the first device 1000 may compare metadata of the first content that is the video with metadata of the second content that is the video. For example, when the second content is a TV program of a soccer game and the first content is a video related to soccer, the genre of the first content and the second content may be ‘sports’, the type of the first content and the second content may be ‘soccer’, and the first device 1000 may determine that the first content is related to the second content.

According to an embodiment, when the first content is execution information of an application and the second content is a video, the first device 1000 may compare metadata of the application with metadata of the video. For example, when the second content is a TV program of a soccer game and the first content is an application presenting information about soccer, the genre of the first content and the second content may be ‘sports’, the type of the first content and the second content may be ‘soccer’, and the first device 1000 may determine that the first content is related to the second content.

According to an embodiment, when the first content is execution information of an application and the second content is a video, the first device 1000 may compare an input query input by a user to the application with metadata of the video. For example, when the second content is a TV program of a soccer game and the first content is execution information of a soccer application that presents video search, the first device 1000 may compare metadata of the second content with a search word input by the user to the soccer application. When the search word input by the user to the soccer application is a search word related to soccer, the first device 1000 may determine that the first content is related to the second content.

When it is determined that the first content is not related to the second content as the determination result of operation 330, the first device 1000 may perform operation S320.

When it is determined that the first content is related to the second content as the determination result of operation 330, in operation S335, the first device 1000 may output a notification for inquiring of the user whether to mirror the first content to the second device 2000. The first device 1000 may display a graphical user interface (GUI) including a text and/or icon for inquiring whether to mirror the first content to the second device 2000, on the screen of the first device 1000. For example, the first device 1000 may overlap and display a GUI for inquiring whether to mirror the first content, on the first content that is being displayed on the screen of the first device 1000. For example, the first device 1000 may display, on the first content, a GUI including a text ‘Select Smart View and enjoy mobile content on TV screen simultaneously.’ and an icon for initiating mirroring.

In operation S340, the first device 1000 may receive a user input for requesting mirroring of the first content. For example, the first device 1000 may receive a user input for selecting a specific icon within the GUI for inquiring whether to mirror the first content.

In operation S345, the first device 1000 may be communicatively connected to the second device 2000. Communication for content mirroring may be established between the first device 1000 and the second device 2000. The first device 1000 may be connected to the second device 2000 through, for example, wireless LAN (Wi-Fi), Bluetooth™, BLE, Zigbee, Wi-Fi Direct (WFD), ultra wideband (UWB), infrared communication (infrared data association (IrDA)), or near field communication (NFC). When communication for mirroring is already established between the first device 1000 and the second device 2000, operation S345 may be omitted.

In operation S350, the first device 1000 may transmit mirroring data of the first content to the second device 2000.

In operation S355, the second device 2000 may display the first content and the second content together.

The second device 2000 may divide the screen of the second device 2000 into two areas, and display the first content and the second content in the respective areas.

All or at least part of operations S300 to S330 of FIG. 3 may correspond to operation S210 of FIG. 2.

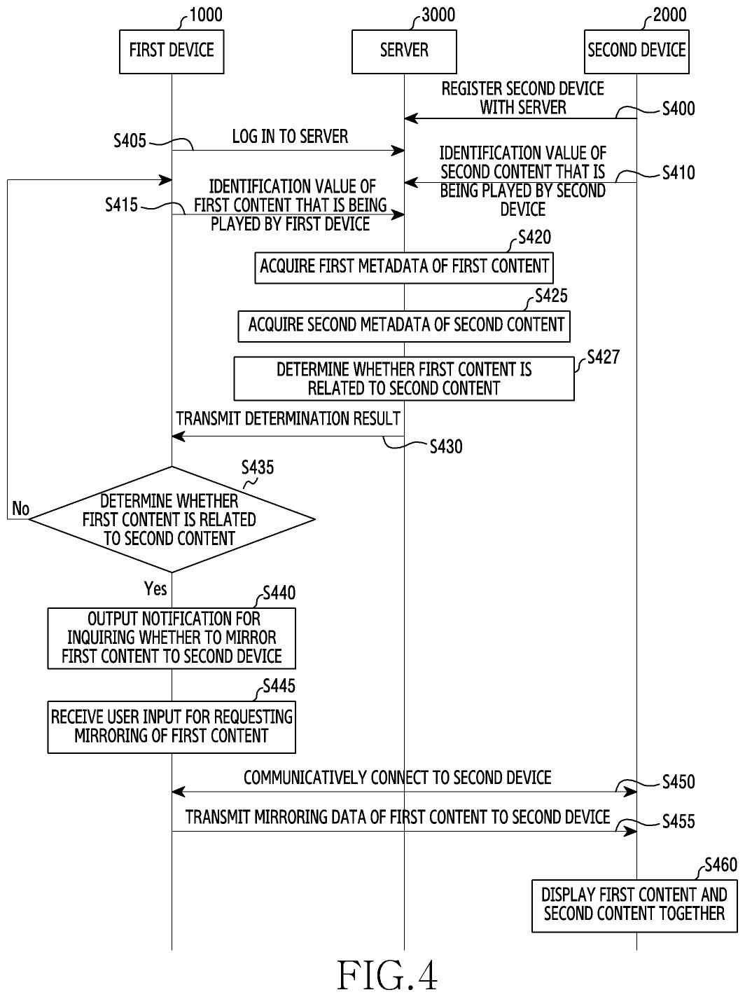

FIG. 4 is a flowchart of a method in which a server determines related content and a first device mirrors first content to a second device according to an embodiment of the disclosure.

In operation S400, a second device 2000 may register the second device 2000 with a server 3000. The server 3000 may present IoT services for user's devices, and a user may register the second device 2000 with the server 3000. The second device 2000 may be registered as a device for a user account of a user who has subscribed to the service of the server 3000. In operation S400, the second device 2000 is described as registering the second device 2000 with the server 3000, but is not limited thereto. The user may register the second device 2000 with the server 3000 by using another device.

In operation S405, a first device 1000 may log in to the server 3000. The first device 1000 may be registered with the IoT service of the server 3000, and the first device 1000 may log in to the IoT service of the server 3000 by using user account information.

In operation S410, the second device 2000 may transmit an identification value of second content that is being played by the second device 2000, to the server 3000. As the second content is displayed by the second device 2000, the second device 2000 may present the identification value of the second content to the server 3000 for the sake of presenting of the IoT service. For example, when a broadcast program is displayed on a screen of the second device 2000, the second device 2000 may transmit a name or channel name of the displayed broadcast program to the server 3000.

In operation S415, the first device 1000 may transmit an identification value of first content that is being played by the first device 1000, to the server 3000. As the first content is displayed by the first device 1000, the first device 1000 may present the identification value of the first content to the server 3000 for the sake of presenting of the IoT service. For example, when a video is displayed on a screen of the first device 1000, the first device 1000 may transmit a title of the displayed video to the server 3000.

In operation S420, the server 3000 may acquire first metadata of the first content. The server 3000 may acquire the first metadata of the first content, based on the identification value of the first content. The server 3000 may request the first metadata of the first content from another server (not shown) that is presenting the first content to the first device 1000, based on the identification value of the first content, and receive the first metadata from another server (not shown). Alternatively, the server 3000 may receive the first metadata together with the identification value of the first content from the first device 1000. When the first device 1000 is registered with the IoT service of the server 3000, the server 3000 may monitor, in real time, information about the first content that is being displayed by the first device 1000.

In operation S425, the server 3000 may acquire second metadata of the second content. The server 3000 may acquire the second metadata of the second content, based on the identification value of the second content. The server 3000 may request the second metadata of the second content from another server (not shown) that is presenting the second content to the second device 2000, based on the identification value of the second content, and receive the second metadata from another server (not shown). Alternatively, the server 3000 may receive the second metadata together with the identification value of the second content from the second device 2000. When the second device 2000 is registered with the IoT service of the server 3000, the server 3000 may monitor, in real time, information about the second content that is being displayed by the second device 2000.

In operation S427, the server 3000 may determine whether the first content is related to the second content. The server 3000 may compare the first metadata with the second metadata and determine whether the first content is related to the second content. In order to determine whether the contents are related to each other, the metadata related to each other may be defined in advance.

According to an embodiment, when the first content and the second content are videos, the server 3000 may compare metadata of the first content that is the video with metadata of the second content that is the video. For example, when the second content is a TV program of a soccer game and the first content is a video related to soccer, the genre of the first content and the second content may be ‘sports’, the type of the first content and the second content may be ‘soccer’, the server 3000 may determine that the first content is related to the second content.

According to an embodiment, when the first content is execution information of an application and the second content is a video, the server 3000 may compare metadata of the application with metadata of the video. For example, when the second content is a TV program of a soccer game and the first content is an application presenting information about soccer, the genre of the first content and the second content may be ‘sports’, the type of the first content and the second content may be ‘soccer’, and the server 3000 may determine that the first content is related to the second content.

According to an embodiment, when the first content is execution information of an application and the second content is a video, the server 3000 may compare an input query input by a user to the application with metadata of the video. For example, when the second content is a TV program of a soccer game and the first content is execution information of a soccer application that presents video search, the server 3000 may compare metadata of the second content with a search word input by the user to the soccer application. When the search word input by the user to the soccer application is a search word related to soccer, the server 3000 may determine that the first content is related to the second content.

In operation S430, the server 3000 may transmit the determination result regarding whether the first content is related to the second content, to the first device 1000, and in operation S435, the first device 1000 may determine whether the first content is related to the second content, based on the received determination result.

When it is determined that the first content is not related to the second content as the determination result of operation 435, the first device 1000 may perform operation S415.

When it is determined that the first content is related to the second content as the determination result of operation 435, in operation S440, the first device 1000 may output a notification for inquiring of the user whether to mirror the first content to the second device 2000, and in operation S445, the first device 1000 may receive a user input for requesting mirroring of the first content.

In operation S450, the first device 1000 may be communicatively connected to the second device 2000. Communication for content mirroring may be established between the first device 1000 and the second device 2000. The first device 1000 may be connected to the second device 2000 through, for example, wireless LAN (Wi-Fi), Bluetooth™, BLE, Zigbee, Wi-Fi Direct (WFD), ultra wideband (UWB), infrared communication (infrared data association (IrDA)), or near field communication (NFC). When communication for mirroring is already connected between the first device 1000 and the second device 2000, operation S450 may be omitted.

In operation S455, the first device 1000 may transmit mirroring data of the first content to the second device 2000, and in operation S460, the second device 2000 may display the first content and the second content together.

All or at least part of operations S400 to S435 of FIG. 4 may correspond to operation S210 of FIG. 2.

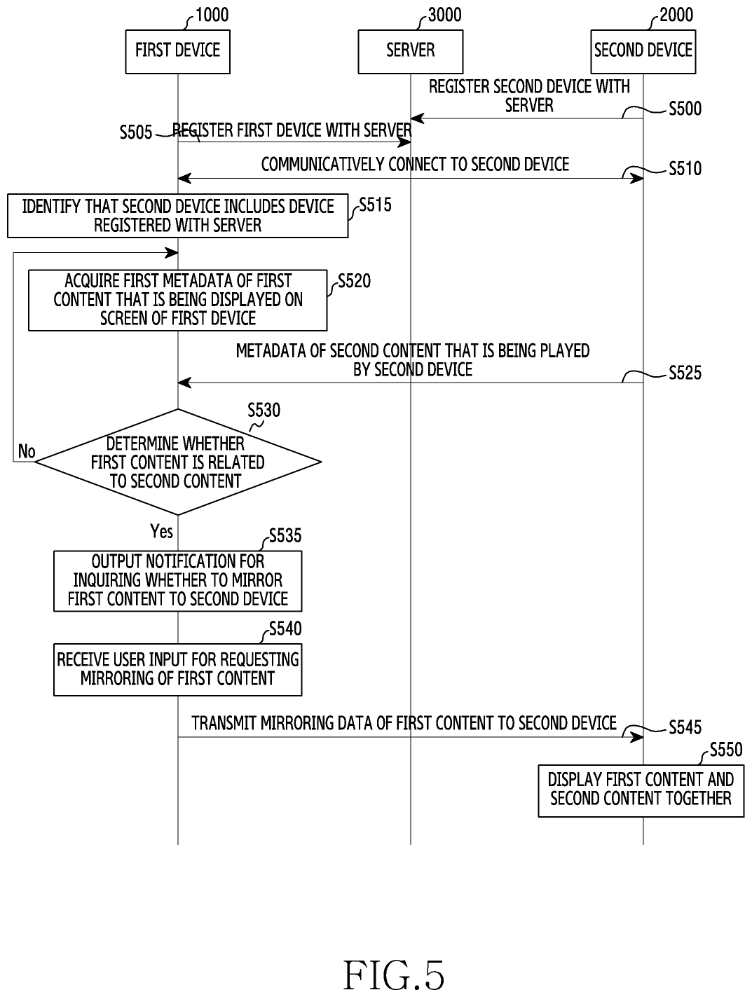

FIG. 5 is a flowchart of a method in which a first device determines related content by using second metadata received from a second device and mirrors first content to the second device according to an embodiment of the disclosure.

In operation S500, a second device 2000 may register the second device 2000 with a server 3000. The server 3000 may present IoT services for user's devices, and a user may register the second device 2000 with the server 3000. The second device 2000 may be registered as a device for a user account of the user who has subscribed to the service of the server 3000. In operation S500, the second device 2000 is described as registering the second device 2000 with the server 3000, but is not limited thereto. The user may register the second device 2000 with the server 3000 by using another device.

In operation S505, a first device 1000 may register the first device 1000 with the server 3000. The server 3000 may present the IoT services for the user's devices, and the user may register the first device 1000 with the server 3000. The first device 1000 may be registered as a device for a user account of the user who has subscribed to the service of the server 3000. In operation S505, the first device 1000 is described as registering the first device 1000 with the server 3000, but is not limited thereto. The user may register the first device 1000 with the server 3000 by using another device.

In operation S510, the first device 1000 may be communicatively connected to the second device 2000. The first device 1000 may be connected to the second device 2000 through, for example, wireless LAN (Wi-Fi), Bluetooth™, BLE, Zigbee, Wi-Fi Direct (WFD), ultra wideband (UWB), infrared communication (infrared data association (IrDA)), or near field communication (NFC).

In operation S515, the first device 1000 may identify that the second device 2000 is a device registered with the server 3000. When the first device 1000 establishes a communication connection with the second device 2000, the first device 1000 may receive device information and user account information of the second device 2000 from the second device 2000. The first device 1000 may identify whether the second device 2000 is a user's device registered with the IoT service of the server 3000 by using the device information and user account information of the second device 2000.

In operation S520, the first device 1000 may acquire first metadata of first content that is being displayed on a screen of the first device 1000, and in operation S525, the first device 1000 may receive second metadata of second content that is being displayed on a screen of the second device 2000 from the second device 2000.

In operation S530, the first device 1000 may determine whether the first content is related to the second content. The first device 1000 may compare the first metadata with the second metadata and determine whether the first content is related to the second content. In order to determine that the contents are related to each other, the metadata related to each other may be defined in advance.

When it is determined that the first content is not related to the second content as the determination result of operation S530, the first device 1000 may perform operation S520.

When it is determined that the first content is related to the second content as the determination result of operation S530, in operation S535, the first device 1000 may output a notification for inquiring of the user whether to mirror the first content to the second device 2000.

In operation S540, the first device 1000 may receive a user input for requesting mirroring of the first content, and in operation S545, the first device 1000 may transmit mirroring data of the first content to the second device 2000.

In operation S550, the second device 2000 may display the first content and the second content together. The second device 2000 may divide the screen of the second device 2000 into two areas and display the first content and the second content in the respective areas.

All or at least part of operations S500 to S530 of FIG. 5 may correspond to operation S210 of FIG. 2.

According to an embodiment, operations S500 and S505 may be performed separately from operations S510 to S550 for allowing the first device 1000 and the second device 2000 to directly communicatively connect with each other and present a mirroring service to the user. For example, when the first device 1000 and the second device 2000 directly communicatively connect with each other and present the mirroring service to the user, operations S500 and S505 may be omitted. In this case, in order for the first device 1000 and the second device 2000 to directly communicatively connect with each other and present the mirroring service to the user, the first device 1000 and the second device 2000 may be registered in advance with the server 3000, but are not limited thereto. For example, in order for the first device 1000 and the second device 2000 to directly communicatively connect with each other and present the mirroring service to the user, the first device 1000 and the second device 2000 may perform mutual authentication as well.

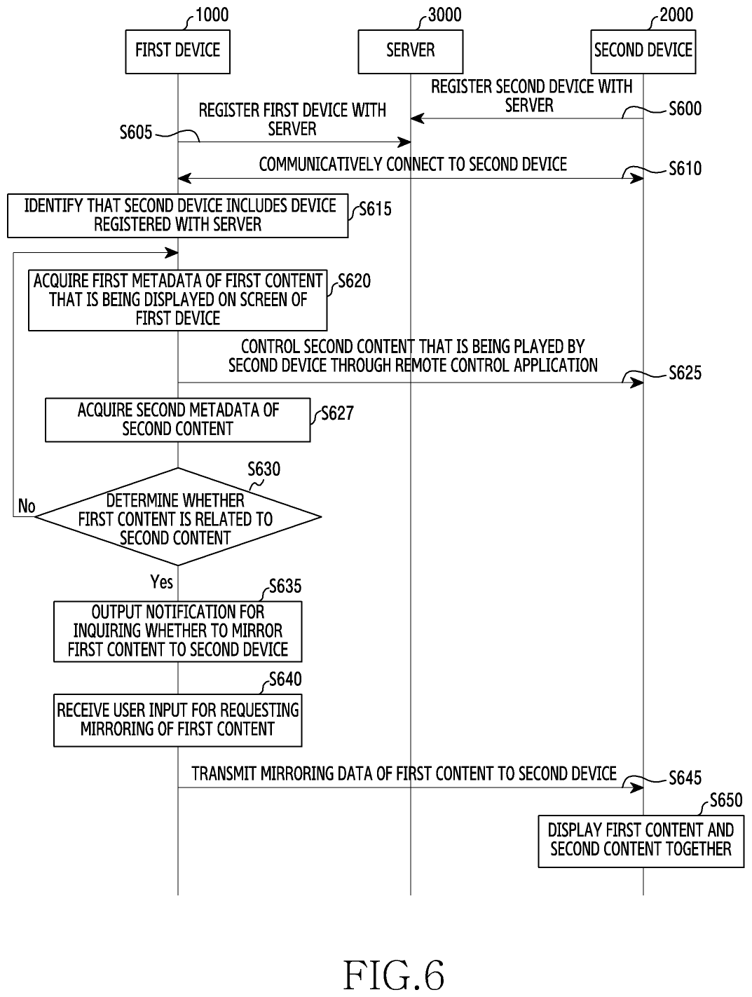

FIG. 6 is a flowchart of a method in which a first device controls second content that is being played by a second device, determines related content by using second metadata of the second content, and mirrors first content to the second device according to an embodiment of the disclosure.

Operations S600, S605, S610, S615, and S620 of FIG. 6 correspond to operations S500, S505, S510, S515, and S520 of FIG. 5, respectively, and operations S630, S635, S640, S645, and S650 of FIG. 6 correspond to operations S530, S535, S540, S545, and S550 of FIG. 5, respectively, and therefore, descriptions of operations S600 to S620 and operations S630 to S650 of FIG. 6 will be omitted for convenience.

In operation S625, a first device 1000 may control second content that is being played by a second device 2000, through a remote control application. By controlling the second device 2000 through the remote control application installed in the first device 1000, the first device 1000 may control the second device 2000 to display the second content. The remote control application may be an application that presents a remote control function for controlling the operation of the second device 2000. For example, the remote control application may be an independent application for controlling the second device 2000. For example, the remote control application is an application that presents an IoT service of the server 3000 and may be an application including the remote control function for controlling the second device 2000.

In operation S627, the first device 1000 acquires second metadata of the second content.

In operation S630, the first device 1000 may acquire second metadata of the second content. As the first device 1000 controls the second device 2000 by using the remote control application, the first device 1000 may identify the second content that is being displayed on a screen of the second device 2000. The first device 1000 may acquire the second metadata of the second content through the remote control application.

According to an embodiment, operations S600 and S605 may be performed separately from operations S610 to S650 for allowing the first device 1000 and the second device 2000 to directly communicatively connect to each other and present a mirroring service to a user. For example, when the first device 1000 and the second device 2000 directly communicatively connect to each other and present the mirroring service to the user, operations S600 and S605 may be omitted. In this case, in order for the first device 1000 and the second device 2000 to directly communicatively connect to each other and present the mirroring service to the user, the first device 1000 and the second device 2000 may be registered in advance with the server 3000, but are not limited thereto. For example, in order for the first device 1000 and the second device 2000 to directly communicatively connect to each other and present the mirroring service to the user, the first device 1000 and the second device 2000 may perform mutual authentication as well.

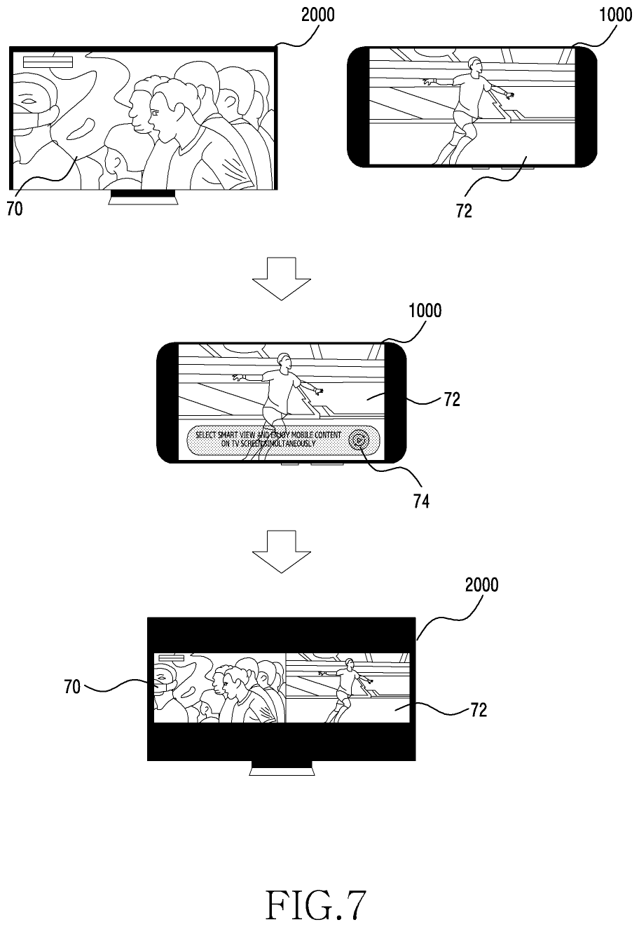

FIG. 7 is a diagram showing an example in which a first device mirrors a first multimedia content to a second device, while the first multimedia content is displayed on a screen of the first device and a second multimedia content is displayed on a screen of the second device according to an embodiment of the disclosure.

Referring to FIG. 7, a second device 2000 may be a TV and a first device 1000 may be a smartphone. While a TV program 70 of a soccer game is displayed on a screen of the second device 2000, a video 72 of another soccer game may be displayed on a screen of the first device 1000. For example, while a user views the soccer game through the second device 2000, the user may operate the first device 1000 and view another soccer game through the first device 1000.

As the video 72 of another soccer game is displayed on the screen of the first device 1000, the first device 1000 may identify whether the TV program 70 of the soccer game is related to the video 72 of another soccer game.

As it is determined that the TV program 70 of the soccer game is related to the video 72 of another soccer game, the first device 1000 may overlap and display a GUI 74 for inquiring of the user whether to mirror the video 72 of another soccer game, on the video 72 of another soccer game.

When a user input for mirroring the video 72 of another soccer game is input through the GUI 74, the first device 1000 may mirror the video 72 of another soccer game to the second device 2000.

The second device 2000 may receive the video 72 of another soccer game from the first device 1000 and display the TV program 70 of the soccer game and the video 72 of another soccer game together on the screen of the second device 2000.

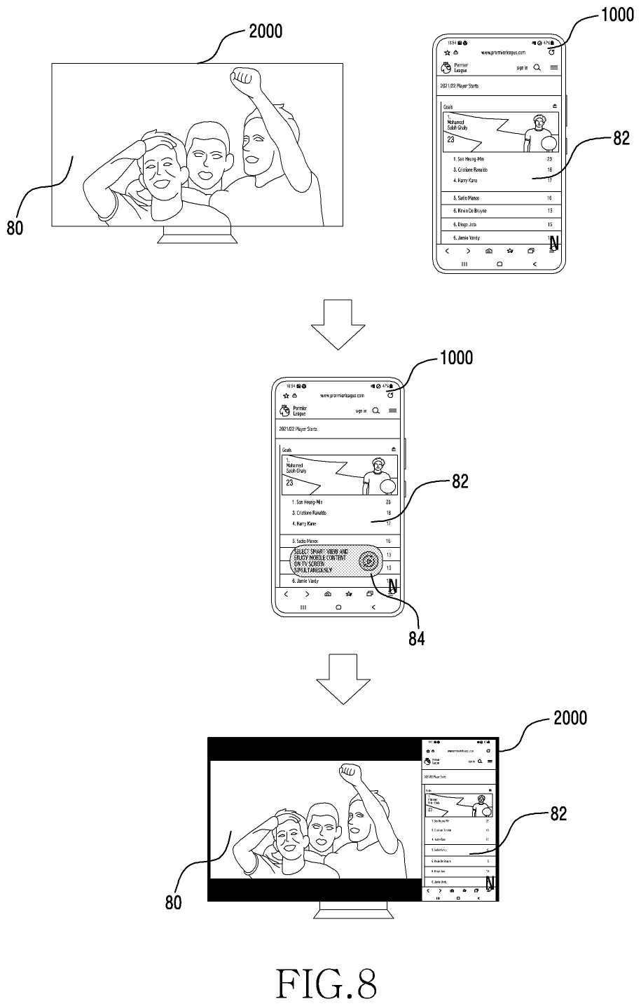

FIG. 8 is a diagram showing an example in which a first device mirrors an application execution screen to a second device, while the application execution screen is displayed on a screen of the first device and a second multimedia content is displayed on a screen of the second device according to an embodiment of the disclosure.

Referring to FIG. 8, a second device 2000 may be a TV and a first device 1000 may be a smartphone. While a TV program 80 of a soccer game is being displayed on a screen of the second device 2000, an execution screen 82 of a soccer application installed in the first device 1000 and presenting soccer information may be displayed on a screen of the first device 1000. For example, while a user views the soccer game through the second device 2000, the user may operate the first device 1000 and execute the soccer application installed in the first device 1000.

As the execution screen 82 of the soccer application is displayed on the screen of the first device 1000, the first device 1000 may identify whether the TV program 80 of the soccer game is related to the execution screen 82 of the soccer application.

As it is identified that the TV program 80 of the soccer game is related to the execution screen 82 of the soccer application, the first device 1000 may overlap and display a GUI 84 for inquiring of a user whether to mirror the execution screen 82 of the soccer application to the second device 2000, on the execution screen 82 of the soccer application.

When a user input for mirroring the execution screen 82 of the soccer application to the second device 2000 is input through the GUI 84 of the first device 1000, the first device 1000 may mirror the execution screen 82 of the soccer application to the second device 2000.

The second device 2000 may receive the execution screen 82 of the soccer application from the first device 1000 and display the TV program 80 of the soccer game and the execution screen 82 of the soccer application together on the screen of the second device 2000.

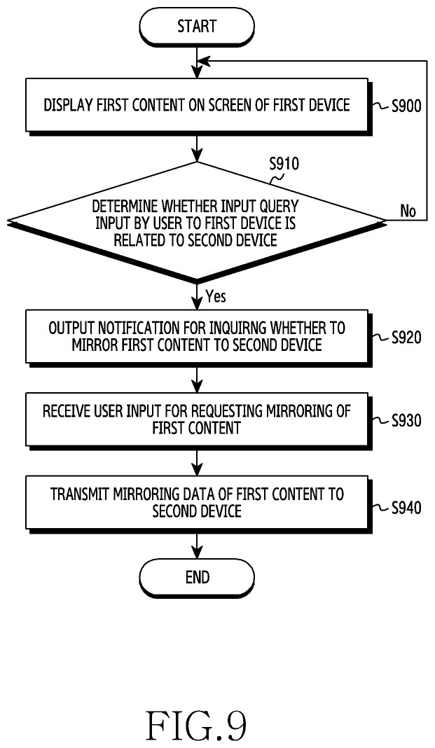

FIG. 9 is a flowchart of a method in which a first device determines related content, based on an input query input from a user through first content, and mirrors the first content to a second device according to an embodiment of the disclosure.

Operations S900, S920, S930 and S940 of FIG. 9 correspond to operations S200, S220, S230 and S240 of FIG. 2 and therefore, descriptions of operations S900, S920, S930 and S940 of FIG. 9 will be omitted for convenience.

In operation S910, a first device 1000 may determine whether an input query input by a user to the first device 1000 is related to second content. The first device 1000 may acquire the input query input by the user to the first device 1000 in relation to first content, and compare the acquired input query with second metadata of the second content. For example, when the first content is an execution screen of an application, the first device 1000 may acquire the input query input by the user through the execution screen of the application. The first device 1000 may compare the input query with the second metadata of the second content, and determine whether the input query is related to the second content.

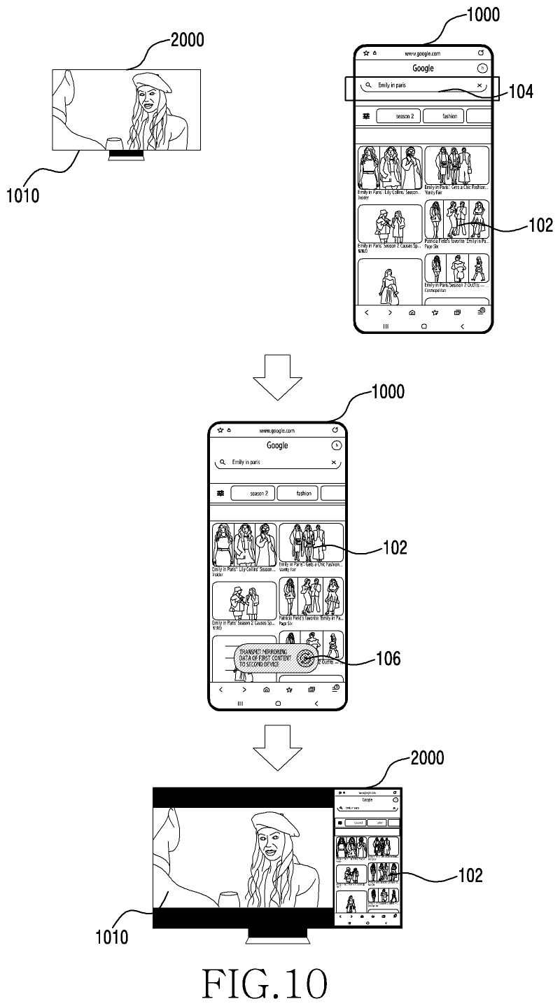

FIG. 10 is a diagram showing an example in which a first device mirrors an execution screen of a search application to a second device, based on an input query input through the execution screen of the search application on a screen of the first device according to an embodiment of the disclosure.

Referring to FIG. 10, a second device 2000 may be a TV and a first device 1000 may be a smartphone. While a movie 1010 in which “Emily” appears is being displayed on a screen of the second device 2000, an execution screen 102 of a search application may be displayed on a screen of the first device 1000. For example, while a user is viewing the movie 1010 in which “Emily” appears through the second device 2000, the user may operate the first device 1000 and execute the search application.

In addition, the first device 1000 may acquire an input query that is input by a user through a search window 104 within the execution screen 102 of the search application. For example, the user may input an input query “Emily in Paris” through the search window 104 within the execution screen 102 of the search application.

As the input query “Emily in Paris” is input through the search window 104 within the execution screen 102 of the search application, the first device 1000 may identify whether the movie 1010 in which “Emily” appears is related to the input query “Emily in Paris”.

As it is determined that the movie 1010 in which “Emily” appears is related to the input query “Emily in Paris”, the first device 1000 may overlap and display a GUI 106 for inquiring of the user whether to mirror the execution screen 102 of the search application to the second device 2000, on the execution screen 102 of the search application.

When a user input for mirroring the execution screen 102 of the search application to the second device 2000 is input through the GUI 106 of the first device 1000, the first device 1000 may mirror the execution screen 102 of the search application to the second device 2000.

The second device 2000 may receive the execution screen 102 of the search application from the first device 1000, and display the movie 1010 in which “Emily” appears and the execution screen 102 of the search application together on the screen of the second device 2000.

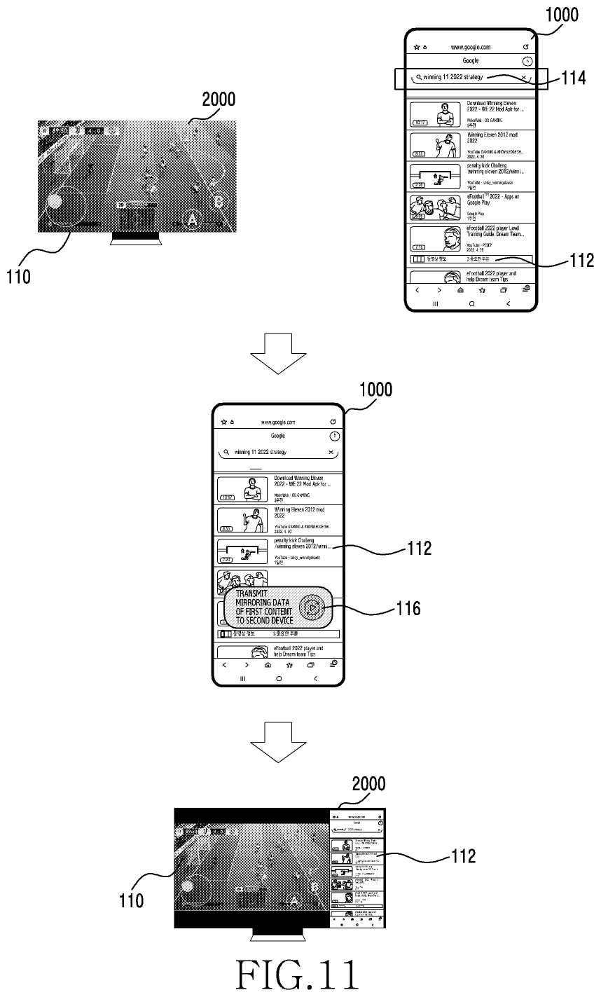

FIG. 11 is a diagram showing an example in which a first device mirrors an execution screen of a video application to a second device, based on an input query input through the execution screen of the video application on a screen of the first device according to an embodiment of the disclosure.

Referring to FIG. 11, a second device 2000 may be a TV and a first device 1000 may be a smartphone. While a soccer game 110 is being displayed on a screen of the second device 2000, an execution screen 112 of a video presenting application installed in the first device 1000 may be displayed on a screen of the first device 1000. For example, while a user is viewing the soccer game 110 through the second device 2000, the user may operate the first device 1000 and execute the video presenting application installed in the first device 1000.

In addition, the first device 1000 may acquire an input query that is input by the user through a search window 114 within the execution screen 112 of the video presenting application. For example, the user may input an input query “winning 11 2022 strategy” through the search window 114 within the execution screen 112 of the video presenting application.

As the input query “winning 11 2022 strategy” is input through the search window 114 within the execution screen 112 of the video presenting application, the first device 1000 may identify whether the soccer game 110 is related to the input query “winning 11 2022 strategy”.

As the first device 1000 determines that the soccer game 110 is related to the input query “winning 11 2022 strategy”, the first device 1000 may overlap and display a GUI 116 for inquiring of the user whether to mirror the execution screen 112 of the video presenting application to the second device 2000, on the execution screen 112 of the video presenting application.

When a user input for mirroring the execution screen 112 of the video presenting application to the second device 2000 is input through the GUI 116 of the first device 1000, the first device 1000 may mirror the execution screen 112 of the video presenting application to the second device 2000.

The second device 2000 may receive the execution screen 112 of the video presenting application from the first device 1000, and display the soccer game 110 and the execution screen 112 of the video presenting application together on the screen of the second device 2000.

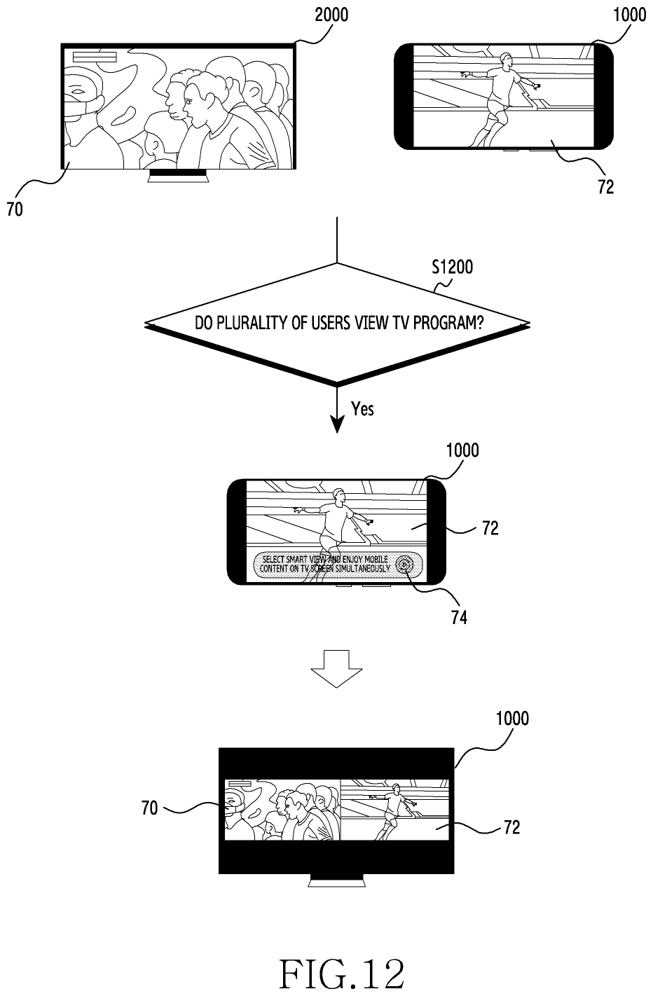

FIG. 12 is a diagram showing an example of presenting a notification for recommending mirroring to a screen of a first device, based on the number of users who view a first multimedia content on the screen of the first device and a second multimedia content on a screen of a second device according to an embodiment of the disclosure.

Referring to FIG. 12, a second device 2000 may be a TV and a first device 1000 may be a smartphone. While a TV program 70 of a soccer game is being displayed on a screen of the second device 2000, a video 72 of another soccer game may be displayed on a screen of the first device 1000. For example, while a user is viewing the soccer game through the second device 2000, the user may operate the first device 1000 and view another soccer game through the first device 1000.

As the video 72 of another soccer game is displayed on the screen of the first device 1000, the first device 1000 may determine whether a plurality of users are viewing the TV program 70 of the soccer game, at operation S1200. The second device 2000 may capture the front before the second device 2000 by using a camera of the second device 2000, and present the captured image to the first device 1000. The first device 1000 may determine whether the plurality of users are viewing the TV program 70 of the soccer game, based on the captured image.

As it is determined that the plurality of users are viewing the TV program 70 of the soccer game, the first device 1000 may identify whether the TV program 70 of the soccer game is related to the video 72 of another soccer game.

As it is determined that the TV program 70 of the soccer game is related to the video 72 of another soccer game, the first device 1000 may overlay and display a GUI 74 for inquiring of the user whether to mirror the video 72 of another soccer game to the second device 2000, on the video 72 of another soccer game.

When a user input for mirroring the video 72 of another soccer game to the second device 2000 is input through the GUI 74 of the first device 1000, the first device 1000 may mirror the video 72 of another soccer game to the second device 2000.

The second device 2000 may receive the video 72 of another soccer game from the first device 1000, and display the TV program 70 of the soccer game and the video 72 of another soccer game together on the screen of the second device 2000.

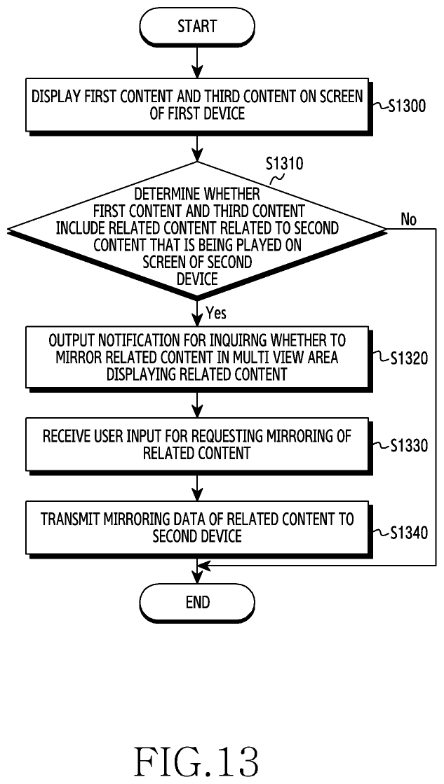

FIG. 13 is a flowchart of a method in which a first device mirrors at least one of a plurality of contents to a second device while the first device is displaying the plurality of contents together according to an embodiment of the disclosure.

In operation S1300, a first device 1000 may display first content and third content together on a screen of the first device 1000. The first device 1000 may divide the screen of the first device 1000 into a plurality of areas, and display the first content and the third content in the divided areas, respectively. For example, the first device 1000 may present a multi view function, and may display the first content in a first area of a multi view and display the third content in a second area of the multi view.

In operation S1310, the first device 1000 may determine whether the first content and the third content are related content related to second content that is being displayed on a screen of the second device 2000. The first device 1000 may compare first metadata of the first content with second metadata of the second content, compare third metadata of the third content with the second metadata of the second content, and determine whether the first content and the third content are the related content related to the second content that is being displayed on the screen of the second device 2000.

According to an embodiment, when the first device 1000 is communicatively connected to the second device 2000, the first device 1000 may receive the second metadata of the second content from the second device 2000, and compare the first metadata and the third metadata with the received second metadata.

According to an embodiment, when the first device 1000 is connected to the server 3000, the first device 1000 may receive the second metadata of the second content from the server 3000, and compare the first metadata and the third metadata with the received second metadata.

According to an embodiment, when the first device 1000 and the second device are connected to the server 3000, the server 3000 may receive the first metadata and the third metadata from the first device 1000, receive the second metadata of the second content from the second device 2000, and compare the first metadata and the third metadata with the second metadata. Based on the metadata comparison result, the server 3000 may determine whether the first metadata and the third metadata are the related content related to the second content and present the determination result to the first device 1000.

When it is determined that the first content is related to the second content as the determination result of operation 1310, in operation S1320, the first device 1000 may output a notification for inquiring whether to mirror related content to the second device 2000, onto a multi view area displaying the related content. The first device 1000 may display a graphical user interface (GUI) including a text and/or icon for inquiring whether to mirror the first content to the second device 2000, onto the multi view area displaying the related content. For example, the first device 1000 may overlap and display a GUI for inquiring whether to mirror the first content, onto the related content that is being displayed on the screen of the first device 1000. For example, the first device 1000 may display, on the related content, a GUI including a text ‘Select Smart View and enjoy mobile content on TV screen simultaneously.’ and an icon for initiating mirroring.

For example, when the first content is the related content, the first device 1000 may display a GUI in an area where the first content is displayed. For example, when the second content is the related content, the first device 1000 may display a GUI in an area where the second content is displayed. For example, when the first content and the second content are the related content, the first device 1000 may display the GUI in the area where the first content is displayed and display the GUI in the area where the second content is displayed.

In operation S1330, the first device 1000 may receive a user input for requesting mirroring of the related content. For example, the first device 1000 may receive a user input for selecting a specific icon within the GUI for inquiring whether to mirror the related content.

In operation S1340, the first device 1000 may mirror the related content to the second device 2000. The first device 1000 may complete a communication connection for mirroring with the second device 2000, and transmit mirroring data of the related content to the second device 2000. The first device 1000 may be connected to the second device 2000 through, for example, wireless LAN (Wi-Fi), Bluetooth™ BLE, Zigbee, Wi-Fi Direct (WFD), ultra wideband (UWB), infrared communication (infrared data association (IrDA)), or near field communication (NFC). When communication for mirroring is already connected between the first device 1000 and the second device 2000, a communication connection operation for mirroring between the first device 1000 and the second device 2000 may be omitted.

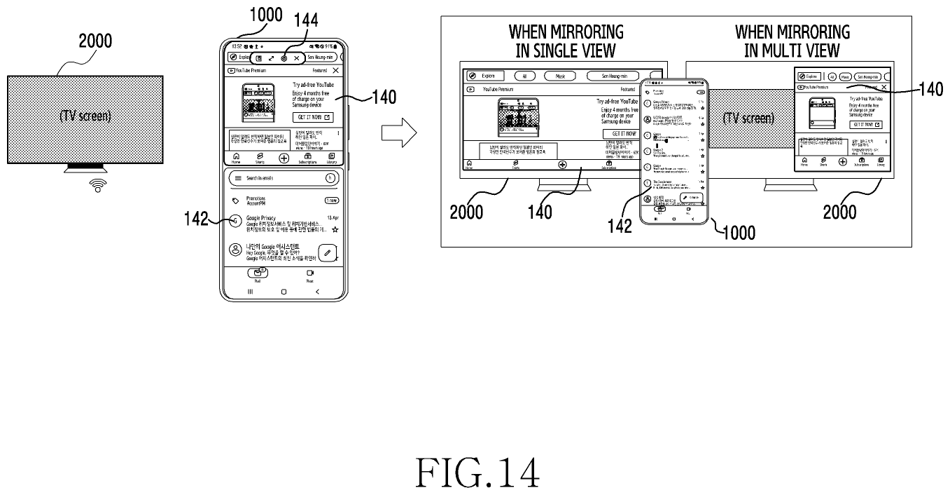

FIG. 14 is a diagram showing an example in which a first device mirrors at least one of a plurality of application execution screens to a second device while displaying the plurality of application execution screens together through a multi view function according to an embodiment of the disclosure.

Referring to FIG. 14, a second device 2000 may be a TV and a first device 1000 may be a smartphone. A screen of the first device 1000 may be divided into two areas, an execution screen 140 of a first application may be displayed in one of the divided areas, and an execution screen 142 of a second application may be displayed in the other of the divided areas.

When the execution screen 140 of the first application is related to second content that is being displayed on a screen of the second device 2000, the first device 1000 may overlap and display a GUI 144 for inquiring of a user whether to mirror related content, on the execution screen 140 of the first application among the execution screen 140 of the first application and the execution screen 142 of the second application.

When a user input for mirroring the related content is input through the GUI 144 of the first device 1000, the first device 1000 may mirror the execution screen 140 of the first application to the second device 2000.

The second device 2000 may receive the execution screen 140 of the first application from the first device 1000, and display the execution screen 140 of the first application on the screen of the second device 2000.

For example, the second device 2000 may display second content in a partial area of the entire screen area of the second device 2000, and display the execution screen 140 of the first application in the other partial area of the entire screen area of the second device 2000.

Alternatively, for example, the second device 2000 may display the execution screen 140 of the first application in the entire screen area of the second device 2000.

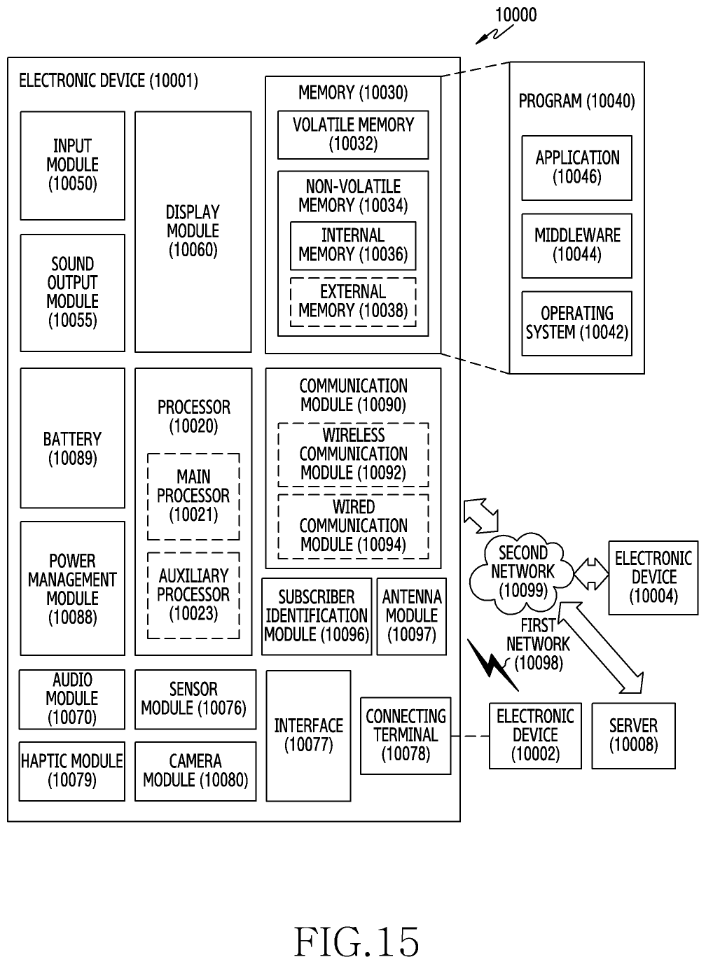

FIG. 15 is a block diagram illustrating an electronic device in a network environment according to an embodiment of the disclosure.

Referring to FIG. 15, an electronic device 10001 in a network environment 10000 may communicate with an electronic device 10002 via a first network 10098 (e.g., a short-range wireless communication network), or at least one of an electronic device 10004 or a server 10008 via a second network 10099 (e.g., a long-range wireless communication network). According to an embodiment, the electronic device 10001 may communicate with the electronic device 10004 via the server 10008. According to an embodiment, the electronic device 10001 may include a processor 10020, memory 10030, an input module 10050, a sound output module 10055, a display module 10060, an audio module 10070, a sensor module 10076, an interface 10077, a connecting terminal 10078, a haptic module 10079, a camera module 10080, a power management module 10088, a battery 10089, a communication module 10090, a subscriber identification module (SIM) 10096, or an antenna module 10097. In some embodiments, at least one of the components (e.g., the connecting terminal 10078) may be omitted from the electronic device 10001, or one or more other components may be added in the electronic device 10001. In some embodiments, some of the components (e.g., the sensor module 10076, the camera module 10080, or the antenna module 10097) may be implemented as a single component (e.g., the display module 10060).

The processor 10020 may execute, for example, software (e.g., a program 10040) to control at least one other component (e.g., a hardware or software component) of the electronic device 10001 coupled with the processor 10020, and may perform various data processing or computation. According to one embodiment, as at least part of the data processing or computation, the processor 10020 may store a command or data received from another component (e.g., the sensor module 10076 or the communication module 10090) in volatile memory 10032, process the command or the data stored in the volatile memory 10032, and store resulting data in non-volatile memory 10034. According to an embodiment, the processor 10020 may include a main processor 10021 (e.g., a central processing unit (CPU) or an application processor (AP)), or an auxiliary processor 10023 (e.g., a graphics processing unit (GPU), a neural processing unit (NPU), an image signal processor (ISP), a sensor hub processor, or a communication processor (CP)) that is operable independently from, or in conjunction with, the main processor 10021. For example, when the electronic device 10001 includes the main processor 10021 and the auxiliary processor 10023, the auxiliary processor 10023 may be adapted to consume less power than the main processor 10021, or to be specific to a specified function. The auxiliary processor 10023 may be implemented as separate from, or as part of the main processor 10021.

The auxiliary processor 10023 may control at least some of functions or states related to at least one component (e.g., the display module 10060, the sensor module 10076, or the communication module 10090) among the components of the electronic device 10001, instead of the main processor 10021 while the main processor 10021 is in an inactive (e.g., sleep) state, or together with the main processor 10021 while the main processor 10021 is in an active state (e.g., executing an application). According to an embodiment, the auxiliary processor 10023 (e.g., an image signal processor or a communication processor) may be implemented as part of another component (e.g., the camera module 10080 or the communication module 10090) functionally related to the auxiliary processor 10023. According to an embodiment, the auxiliary processor 10023 (e.g., the neural processing unit) may include a hardware structure specified for artificial intelligence model processing. An artificial intelligence model may be generated by machine learning. Such learning may be performed, e.g., by the electronic device 10001 where the artificial intelligence is performed or via a separate server (e.g., the server 10008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 10030 may store various data used by at least one component (e.g., the processor 10020 or the sensor module 10076) of the electronic device 10001. The various data may include, for example, software (e.g., the program 10040) and input data or output data for a command related thereto. The memory 10030 may include the volatile memory 10032 or the non-volatile memory 10034.

The program 10040 may be stored in the memory 10030 as software, and may include, for example, an operating system (OS) 10042, middleware 10044, or an application 10046.

The input module 10050 may receive a command or data to be used by another component (e.g., the processor 10020) of the electronic device 10001, from the outside (e.g., a user) of the electronic device 10001. The input module 10050 may include, for example, a microphone, a mouse, a keyboard, a key (e.g., a button), or a digital pen (e.g., a stylus pen).

The sound output module 10055 may output sound signals to the outside of the electronic device 10001. The sound output module 10055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 10060 may visually provide information to the outside (e.g., a user) of the electronic device 10001. The display module 10060 may include, for example, a display, a hologram device, or a projector and control circuitry to control a corresponding one of the display, hologram device, and projector. According to an embodiment, the display module 10060 may include a touch sensor adapted to detect a touch, or a pressure sensor adapted to measure the intensity of force incurred by the touch.

The audio module 10070 may convert a sound into an electrical signal and vice versa. According to an embodiment, the audio module 10070 may obtain the sound via the input module 10050, or output the sound via the sound output module 10055 or a headphone of an external electronic device (e.g., the electronic device 10002) directly (e.g., wiredly) or wirelessly coupled with the electronic device 10001.

The sensor module 10076 may detect an operational state (e.g., power or temperature) of the electronic device 10001 or an environmental state (e.g., a state of a user) external to the electronic device 10001, and then generate an electrical signal or data value corresponding to the detected state. According to an embodiment, the sensor module 10076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 10077 may support one or more specified protocols to be used for the electronic device 10001 to be coupled with the external electronic device (e.g., the electronic device 10002) directly (e.g., wiredly) or wirelessly. According to an embodiment, the interface 10077 may include, for example, a high definition multimedia interface (HDMI), a universal serial bus (USB) interface, a secure digital (SD) card interface, or an audio interface.

The connecting terminal 10078 may include a connector via which the electronic device 10001 may be physically connected with the external electronic device (e.g., the electronic device 10002). According to an embodiment, the connecting terminal 10078 may include, for example, a HDMI connector, a USB connector, a SD card connector, or an audio connector (e.g., a headphone connector).

The haptic module 10079 may convert an electrical signal into a mechanical stimulus (e.g., a vibration or a movement) or electrical stimulus which may be recognized by a user via his tactile sensation or kinesthetic sensation. According to an embodiment, the haptic module 10079 may include, for example, a motor, a piezoelectric element, or an electric stimulator.

The camera module 10080 may capture a still image or moving images. According to an embodiment, the camera module 10080 may include one or more lenses, image sensors, image signal processors, or flashes.

The power management module 10088 may manage power supplied to the electronic device 10001. According to one embodiment, the power management module 10088 may be implemented as at least part of, for example, a power management integrated circuit (PMIC).

The battery 10089 may supply power to at least one component of the electronic device 10001. According to an embodiment, the battery 10089 may include, for example, a primary cell which is not rechargeable, a secondary cell which is rechargeable, or a fuel cell.

The communication module 10090 may support establishing a direct (e.g., wired) communication channel or a wireless communication channel between the electronic device 10001 and the external electronic device (e.g., the electronic device 10002, the electronic device 10004, or the server 10008) and performing communication via the established communication channel. The communication module 10090 may include one or more communication processors that are operable independently from the processor 10020 (e.g., the application processor (AP)) and supports a direct (e.g., wired) communication or a wireless communication. According to an embodiment, the communication module 10090 may include a wireless communication module 10092 (e.g., a cellular communication module, a short-range wireless communication module, or a global navigation satellite system (GNSS) communication module) or a wired communication module 10094 (e.g., a local area network (LAN) communication module or a power line communication (PLC) module). A corresponding one of these communication modules may communicate with the external electronic device via the first network 10098 (e.g., a short-range communication network, such as Bluetooth™, wireless-fidelity (Wi-Fi) direct, or infrared data association (IrDA)) or the second network 10099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 10092 may identify and authenticate the electronic device 10001 in a communication network, such as the first network 10098 or the second network 10099, using subscriber information (e.g., international mobile subscriber identity (IMSI)) stored in the subscriber identification module 10096.

The wireless communication module 10092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 10092 may support a high-frequency band (e.g., the millimeter wave (mm Wave) band) to achieve, e.g., a high data transmission rate. The wireless communication module 10092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 10092 may support various requirements specified in the electronic device 10001, an external electronic device (e.g., the electronic device 10004), or a network system (e.g., the second network 10099). According to an embodiment, the wireless communication module 10092 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 10097 may transmit or receive a signal or power to or from the outside (e.g., the external electronic device) of the electronic device 10001. According to an embodiment, the antenna module 10097 may include an antenna including a radiating element composed of a conductive material or a conductive pattern formed in or on a substrate (e.g., a printed circuit board (PCB)). According to an embodiment, the antenna module 10097 may include a plurality of antennas (e.g., array antennas). In such a case, at least one antenna appropriate for a communication scheme used in the communication network, such as the first network 10098 or the second network 10099, may be selected, for example, by the communication module 10090 (e.g., the wireless communication module 10092) from the plurality of antennas. The signal or the power may then be transmitted or received between the communication module 10090 and the external electronic device via the selected at least one antenna. According to an embodiment, another component (e.g., a radio frequency integrated circuit (RFIC)) other than the radiating element may be additionally formed as part of the antenna module 10097.

According to various embodiments, the antenna module 10097 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 10001 and the external electronic device 10004 via the server 10008 coupled with the second network 10099. Each of the electronic devices 10002 or 10004 may be a device of a same type as, or a different type, from the electronic device 10001. According to an embodiment, all or some of operations to be executed at the electronic device 10001 may be executed at one or more of the external electronic devices (e.g., electronic devices 10002 and 10004 and the server 10008. For example, if the electronic device 10001 should perform a function or a service automatically, or in response to a request from a user or another device, the electronic device 10001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 10001. The electronic device 10001 may provide the outcome, with or without further processing of the outcome, as at least part of a reply to the request. To that end, a cloud computing, distributed computing, mobile edge computing (MEC), or client-server computing technology may be used, for example. The electronic device 10001 may provide ultra low-latency services using, e.g., distributed computing or mobile edge computing. In another embodiment, the external electronic device 10004 may include an internet-of-things (IoT) device. The server 10008 may be an intelligent server using machine learning and/or a neural network. According to an embodiment, the external electronic device 10004 or the server 10008 may be included in the second network 10099. The electronic device 10001 may be applied to intelligent services (e.g., smart home, smart city, smart car, or healthcare) based on 5G communication technology or IoT-related technology.

The electronic device 10001 of FIG. 15 may be a first device 1000 or a second device 2000.

According to an embodiment, when the electronic device 10001 of FIG. 15 is the first device 1000, the electronic device 10001 may perform the operation of the first device 1000 of FIGS. 1 to 14.

When the electronic device 10001 is the first device 1000, the electronic device 10001 may display first content on a screen of the electronic device 10001. The electronic device 10001 may display the first content on the screen of the electronic device 10001 while second content is being displayed on a screen of the second device 2000.

For example, the first content may include, but is not limited to, multimedia content and/or an execution screen of an application. For example, when the electronic device 10001 is a smartphone, the first content may be a video or an execution screen of a specific application that is being displayed on the screen of the electronic device 10001. For example, the second content may include, but is not limited to, multimedia content and/or an execution screen of an application. For example, when the second device 2000 is a TV, the second content may be content of a TV program that is being displayed on the screen of the second device 2000.

The electronic device 10001 may identify whether the first content is related to the second content that is being displayed on the screen of the second device 2000. When the display of the first content on the screen of the electronic device 10001 starts while the second content is being displayed on the screen of the second device 2000, the electronic device 10001 may identify whether the first content is related to the second content. The electronic device 10001 may compare first metadata of the first content with second metadata of the second content and determine or identify whether the first content is related to the second content.

For example, when the electronic device 10001 is communicatively connected to the second device 2000, the electronic device 10001 may receive the second metadata of the second content from the second device 2000, and compare the first metadata with the received second metadata.

For example, when the electronic device 10001 is connected to a server 3000, the electronic device 10001 may receive the second metadata of the second content from the server 3000, and compare the first metadata with the received second metadata.

For example, when the electronic device 10001 and the second device 2000 are connected to the server 3000, the server 3000 may receive the first metadata of the first content from the electronic device 10001, receive the second metadata of the second content from the second device 2000, and compare the first metadata with the second metadata. Based on the comparison result of the first metadata and the second metadata, the server 3000 may determine whether the first content is related to the second content, and present the determination result to the electronic device 10001.

When it is determined that the first content is related to the second content, the electronic device 10001 may output a notification for inquiring of a user whether to mirror the first content to the second device 2000. The electronic device 10001 may display a graphical user interface (GUI) including a text and/or icon for inquiring whether to mirror the first content to the second device 2000, on the screen of the electronic device 10001. For example, the electronic device 10001 may overlap and display a GUI for inquiring whether to mirror the first content, on the first content that is being displayed on the screen of the electronic device 10001. For example, the first device 1000 may display, on the first content, a GUI including a text ‘Select Smart View and enjoy mobile content on TV screen simultaneously.’ and an icon for initiating mirroring.

The electronic device 10001 may receive a user input for requesting mirroring of the first content. For example, the electronic device 10001 may receive a user input for selecting a specific icon within a GUI for inquiring whether to mirror the first content.

The electronic device 10001 may mirror the first content to the second device 2000. The electronic device 10001 may complete a communication connection for mirroring with the second device 2000, and transmit mirroring data of the first content to the second device 2000. The electronic device 10001 may be connected to the second device 2000 through, for example, wireless LAN (Wi-Fi), Bluetooth™, BLE, Zigbee, Wi-Fi Direct (WFD), ultra wideband (UWB), infrared communication (infrared data association (IrDA)), or near field communication (NFC). When communication for mirroring is already connected between the electronic device 10001 and the second device 2000, a communication connection operation for mirroring between the electronic device 10001 and the second device 2000 may be omitted.

According to an embodiment, when the electronic device 10001 of FIG. 15 is the second device 2000, the electronic device 10001 may perform the operation of the second device 2000 in FIGS. 1 to 14.

When the electronic device 10001 is the second device 2000, the electronic device 10001 may register the electronic device 10001 with the server 3000. The server 3000 may present IoT services for user's devices, and a user may register the electronic device 10001 with the server 3000. The electronic device 10001 may be registered as a device for a user account of the user who has subscribed to the service of the server 3000. Although the electronic device 10001 is described above as registering the electronic device 10001 with the server 3000, it is not limited thereto. The user may register the electronic device 10001 with the server 3000 by using another device.

The electronic device 10001 may transmit an identification value of second content that is being played by the electronic device 10001, to the server 3000. As the second content is displayed by the electronic device 10001, the electronic device 10001 may present the identification value of the second content to the server 3000 and present an IoT service of the server 3000. For example, when a broadcast program is displayed on a screen of the electronic device 10001, the electronic device 10001 may transmit a name or channel name of the displayed broadcast program to the server 3000. The identification value of the second content transmitted to the server 3000 may be used for when the server 3000 or the first device 1000 determines whether the first content is related to the second content.

The electronic device 10001 may be communicatively connected to the first device 1000. The electronic device 10001 may be connected to the first device 1000 through, for example, wireless LAN (Wi-Fi), Bluetooth™, BLE, Zigbee, Wi-Fi Direct (WFD), ultra wideband (UWB), infrared communication (infrared data association (IrDA)), or near field communication (NFC).

The electronic device 10001 may transmit, to the first device 1000, second metadata of the second content that is being displayed on the screen of the electronic device 10001. The identification value of the second content transmitted to the first device 1000 may be used for when the first device 1000 determines whether the first content is related to the second content.

The second content that is being played by the electronic device 10001 may be controlled through a remote control application of the first device 1000. By controlling the electronic device 10001 through the remote control application installed in the first device 1000, the first device 1000 may control the electronic device 10001 to display the second content on the screen of the electronic device 10001. The remote control application of the first device 1000 may be an application that presents a remote control function for controlling the operation of the electronic device 10001. For example, the remote control application may be an independent application for controlling the electronic device 10001. For example, the remote control application is an application that presents an IoT service of the server 3000, and may be an application including the remote control function for controlling the electronic device 10001. As the second content that is being played by the electronic device 10001 is controlled by the remote control application of the first device 1000, information about the second content that is being played by the electronic device 10001 may be presented to the first device 1000.

The electronic device 10001 may receive the first content mirrored from the first device 1000, and display the first content and the second content together. The electronic device 10001 may divide the screen of the electronic device 10001 into two areas, and display the first content and the second content in the respective areas.

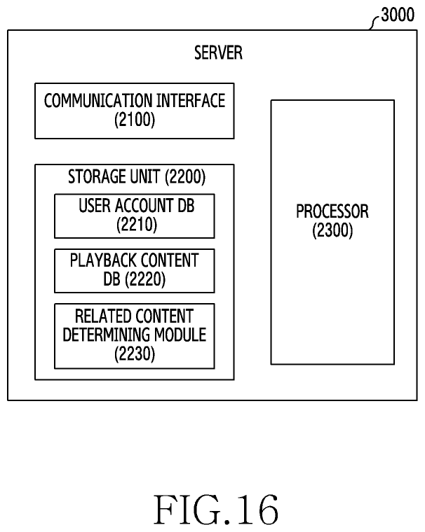

FIG. 16 is a block diagram of a server according to an embodiment of the disclosure.

Referring to FIG. 16, a server 3000 of an embodiment may include a communication interface 2100, a storage unit 2200, and a processor 2300. The storage unit 2200 may include a user account database (DB) 2210, a playback content DB 2220, and a related content determining module 2230.

The communication interface 2100 may include one or more components for communicating with a first device 1000 and/or a second device 2000. The communication interface 2100 may transmit and receive information necessary for determining related content to and from the first device 1000 and/or the second device 2000. In addition, the communication interface 2100 may communicate with other devices (not shown) and other servers (not shown). For example, the communication interface 2100 may include a wireless communication module (e.g., cellular communication module, short-range wireless communication module, or global navigation satellite system (GNSS) communication module) or a wired communication module (e.g., local area network (LAN) communication module or power line communication module). Among these communication modules, the corresponding communication module may communicate with an external electronic device through a first network (e.g., short-range communication network such as Bluetooth™, wireless fidelity (Wi-Fi) direct, or infrared data association (IrDA)) or a second network (e.g., long-range communication network such as legacy cellular network, 5G network, next-generation communication network, Internet, or computer network (e.g., LAN or WAN)).

The processor 2300 controls the overall operation of the server 3000. For example, the processor 2300 may execute programs stored in the storage unit 2200 described below and control the function of the server 3000 necessary for determining related content in this specification. The processor 2300 may execute software (e.g., program) and control at least one other component (e.g., hardware or software component) connected to the processor 2030, and may perform various data processing or calculations.

The storage unit 2200 may store a program for processing and controlling the processor 2300. The storage unit 2200 may include at least one type of storage medium among flash memory type, hard disk type, multimedia card micro type, card type memory (for example, SD or XD memory, etc.), random access memory (RAM), static random access memory (SRAM), read-only memory (ROM), electrically erasable programmable read-only memory (EEPROM), programmable read-only memory (PROM), magnetic memory, magnetic disk, and optical disk.

The storage unit 2200 may include the user account DB 2210, the playback content DB 2220, and the related content determining module 2230.

The user account DB 2210 may store user accounts for managing devices and users receiving an IoT service of the server 3000. The user subscribes to the IoT service of the server 3000, whereby the server 3000 may register the user account of the user with the server 3000. In addition, the first device 1000, second device 2000 and other devices of the user may be registered with the server 3000. The first device 1000, second device 2000 and other devices of the user may be registered as devices for the user account of the user who has subscribed to the IoT service of the server 3000. The user account DB 2210 may store information about the user and information about the user's devices.

The playback content DB 2220 may store information about content played by the first device 1000 and/or the second device 2000. When the first device 1000 is registered with the IoT service of the server 3000, the server 3000 may acquire information about first content that is being displayed by the first device 1000 in real time or periodically, and store the information about the first content in the playback content DB 2220. When the second device 2000 is registered with the IoT service of the server 3000, the server 3000 may acquire information about second content that is being displayed by the second device 2000 in real time or periodically, and store the information about the second content in the playback content DB 2220. The playback content DB 2220 may store first metadata of the first content and second metadata of the second content, but is not limited thereto.

The related content determining module 2230 may determine whether the first content is related to the second content.

The related content determining module 2230 may acquire the first metadata of the first content, based on an identification value of the first content, and acquire the second metadata of the second content, based on an identification value of the second content. In addition, the related content determining module 2230 may store the first metadata and the second metadata in the playback content DB 2220.

The related content determining module 2230 may request the first metadata of the first content from another server (not shown) that presents the first content to the first device 1000, and receive the first metadata from another server (not shown). Alternatively, the related content determining module 2230 may receive the first metadata together with the identification value of the first content from the first device 1000.

The related content determining module 2230 may request the second metadata of the second content from another server (not shown) that presents the second content to the second device 2000, and receive the second metadata from another server (not shown). Alternatively, the related content determining module 2230 may receive the second metadata together with the identification value of the second content from the second device 2000.

The related content determining module 2230 may compare the first metadata with the second metadata and determine whether the first content is related to the second content. In order to determine that the contents are related to each other, the metadata related to each other may be defined in advance.

According to an embodiment, when the first content and the second content are videos, the related content determining module 2230 may compare metadata of the first content that is the video with metadata of the second content that is the video. For example, when the second content is a TV program of a soccer game and the first content is a video related to soccer, the genre of the first content and the second content may be ‘sports’, the type of the first content and the second content may be ‘soccer’, and the related content determining module 2230 may determine that the first content is related to the second content.

According to an embodiment, when the first content is execution information of an application and the second content is a video, the related content determining module 2230 may compare metadata of the application with metadata of the video. For example, when the second content is a TV program of a soccer game and the first content is an application presenting information about soccer, the genre of the first content and the second content may be ‘sports’, the type of the first content and the second content may be ‘soccer’, and the related content determining module 2230 may determine that the first content is related to the second content.

According to an embodiment, when the first content is execution information of an application and the second content is a video, the related content determining module 2230 may compare an input query input by a user to the application with metadata of the video. For example, when the second content is a TV program of a soccer game and the first content is execution information of a soccer application presenting video search, the related content determining module 2230 may compare metadata of the second content with a search word input by the user to the soccer application. When the search word input by the user to the soccer application is a search word related to soccer, the related content determining module 2230 may determine that the first content is related to the second content.

The communication interface 2100 may transmit the determination result regarding whether the first content is related to the second content, to the first device 1000, and the first device 1000 may determine whether the first content is related to the second content, based on the received determination result.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 10040) including one or more instructions that are stored in a storage medium (e.g., internal memory 10036 or external memory 10038) that is readable by a machine (e.g., the electronic device 10001). For example, a processor (e.g., the processor 10020) of the machine (e.g., the electronic device 10001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The above description of the disclosure is for ˜˜ purposes, and those skilled in the art to which the disclosure pertains will understand that the disclosure may be easily modified into other specific forms without changing the technical idea or essential characteristics of the disclosure. Therefore, it should be understood that the embodiments described above are ˜˜ in all respects and are not restrictive. For example, each component described as a single component may be also embodied in a distributed manner, and likewise, components described as distributed may be embodied in a combined manner.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A first device for mirroring content to a second device, the first device comprising:
a communication interface;
a display;
memory storing one or more computer programs; and
one or more processors communicatively coupled to the communication interface, the display, and the memory,
wherein the one or more processors include computer-executable instructions that, when executed by the one or more processors individually or collectively, cause the first device to:
display first content on a screen of the first device,
receive, from the second device, information related to second content that is being displayed on a screen of the second device,
compare the information related to the second content with information related to the first content and determine whether the first content is related to the second content,
output a notification inquiring a user whether to mirror the first content to the second device when it is determined that the first content is related to the second content,
receive a user input with respect to the notification, and
mirror the first content to the second device in response to receiving the user input.

2. The first device of claim 1,
wherein the information related to the first content comprises first metadata of the first content,
wherein the information related to the second content comprises second metadata of the second content, and
wherein whether the first content is related to the second content is determined based on the first metadata of the first content and the second metadata of the second content.

3. The first device of claim 2,
wherein the first device and the second device are devices registered with a server presenting an Internet of things (IoT) service, and
wherein the one or more processors further include computer-executable instructions that, when executed by the one or more processors individually or collectively, cause the first device to:
request the second metadata of the second content from the server,
receive, from the server, the second metadata of the second content, and
compare the first metadata of the first content with the second metadata of the second content.

4. The first device of claim 2, wherein the one or more processors further include computer-executable instructions that, when executed by the one or more processors individually or collectively, cause the first device to:
execute a remote control application for controlling the second content displayed on the screen of the second device,
control the second content displayed on the screen of the second device through the remote control application,
identify the second content, based on the controlling of the second content,
receive, from the second device, the second metadata of the second content, and
compare the first metadata of the first content with the second metadata of the second content.

5. The first device of claim 4, wherein the one or more processors further include computer-executable instructions that, when executed by the one or more processors individually or collectively, cause the first device to:
receive the second metadata from the second device through the remote control application.

6. The first device of claim 2,
wherein the first content includes multimedia content, and
wherein the first metadata of the first content comprises at least one of a name, a genre, a category, or a character of the multimedia content.

7. The first device of claim 2,
wherein the first content corresponds to content of an application presenting a specific service, and
wherein the first metadata of the first content comprises at least one of a name of the application, a category, or a keyword comprised in an execution screen of the application.

8. The first device of claim 2, wherein the first metadata comprises an input query input by the user to the first device in relation to the first content.

9. The first device of claim 1, wherein the one or more processors further include computer-executable instructions that, when executed by the one or more processors individually or collectively, cause the first device to:
identify a plurality of users who view the first content displayed on the screen of the first device and the second content displayed on the screen of the second device, the plurality of users comprising the user, and
output the notification when it is determined that the first content is related to the second content and the plurality of users are identified.

10. The first device of claim 1, wherein the one or more processors further include computer-executable instructions that, when executed by the one or more processors individually or collectively, cause the first device to:
display the first content and third content together on the screen of the first device, and
display a graphical user interface (GUI) for mirroring at least one of the first content or the third content to the second device, in at least one of an area in which the first content is displayed or an area in which the third content is displayed.

11. A method performed by a first device for mirroring content to a second device, the method comprising:
displaying, by the first device, first content on a screen of the first device;
receiving, by the first device from the second device, information related to second content that is being displayed on a screen of the second device;
comparing, by the first device, the information related to the second content with information related to the first content and determining, by the first device, whether the first content is related to the second content;
outputting, by the first device, a notification inquiring a user whether to mirror the first content to the second device based on determining that the first content is related to the second content;
receiving, by the first device, a user input with respect to the notification; and
mirroring, by the first device, the first content to the second device in response to receiving the user input.

12. The method of claim 11,
wherein the information related to the first content comprises first metadata of the first content,
wherein the information related to the second content comprises second metadata of the second content, and
wherein whether the first content is related to the second content is determined based on the first metadata of the first content and the second metadata of the second content.

13. The method of claim 12,
wherein the first device and the second device are devices registered with a server presenting an Internet of things (IoT) service, and
wherein the determining of whether the first content is related to the second content comprises:
requesting, by the first device, the second metadata of the second content from the server;
receiving, by the first device from the server, the second metadata of the second content; and
comparing, by the first device, the first metadata of the first content with the second metadata of the second content.

14. The method of claim 12, further comprising:
executing, by the first device, a remote control application for controlling the second content displayed on the screen of the second device;
controlling, by the first device, the second content displayed on the screen of the second device through the remote control application; and
identifying, by the first device, the second content based on the controlling of the second content,
wherein the determining of whether the first content is related to the second content comprises:
receiving, by the first device from the second device, the second metadata of the second content, and
comparing the first metadata of the first content with the second metadata of the second content.

15. The method of claim 14, wherein the receiving of the second metadata of the second content comprises receiving, by the first device, the second metadata from the second device through the remote control application.

16. The method of claim 12,
wherein the first content includes multimedia content, and
wherein the first metadata of the first content comprises at least one of a name, a genre, a category, or a character of the multimedia content.

17. The method of claim 12,
wherein the first content corresponds to content of an application presenting a specific service, and
wherein the first metadata of the first content comprises at least one of a name of the application, a category, or a keyword comprised in an execution screen of the application.

18. The method of claim 12, wherein the first metadata comprises an input query input by the user to the first device in relation to the first content.

19. One or more non-transitory computer-readable storage media storing one or more computer programs including computer-executable instructions that, when executed by one or more processors of a first device individually or collectively, cause the first device to perform operations, the operations comprising:
displaying, by the first device, first content on a screen of the first device;
receiving, by the first device from a second device, information related to second content that is being displayed on a screen of the second device;
comparing, by the first device, the information related to the second content with information related to the first content and determining, by the first device, whether the first content is related to the second content;
outputting, by the first device, a notification inquiring a user whether to mirror the first content to the second device based on determining that the first content is related to the second content;
receiving, by the first device, a user input with respect to the notification; and
mirroring, by the first device, the first content to the second device in response to receiving the user input.

20. The one or more non-transitory computer-readable storage media of claim 19,
wherein the information related to the first content comprises first metadata of the first content,
wherein the information related to the second content comprises second metadata of the second content, and
wherein whether the first content is related to the second content is determined based on the first metadata of the first content and the second metadata of the second content.
